(19) United States
(12) Patent Application Publication
(10) Pub. No.: US 2022/0172184 A1
(43) Pub. Date: Jun. 2, 2022

(54) SYSTEM AND METHOD FOR MANAGING INCARCERATED POPULATIONS THROUGH AUTOMATED PRETRIAL RELEASE SERVICES INCLUDING ELECTRONIC BAIL, FINE AND FEE PAYMENT

(71) Applicant: Allpaid, Inc., Indianapolis, IN (US)

(72) Inventors: Dale W. Conrad, Fortville, IN (US); Michael J. Stoller, Silver Spring, MD (US); Brian G. Kibble-Smith, Oak Park, IL (US)

(21) Appl. No.: 17/546,660

(22) Filed: Dec. 9, 2021

Related U.S. Application Data
(63) Continuation of application No. 16/188,538, filed on Nov. 13, 2018, now abandoned.
Application No. 16/188,538 is a continuation of application No. 15/253,058, filed on Aug. 31, 2016, now abandoned.
Application No. 15/253,058 is a continuation of application No. 12/982,500, filed on Dec. 30, 2010, now abandoned.
(60) Provisional application No. 61/308,075, filed on Feb. 25, 2010.

(51) Int. Cl. G06Q 20/08; G06Q 50/26; G06Q 20/10

(52) U.S. Cl. CPC G06Q 20/0855; G06Q 20/10; G06Q 20/085; G06Q 50/26

(57) ABSTRACT

A user-focused system and method is provided in the pretrial release field to be used primarily for assisting incarcerated individuals to explore, understand and expedite various options for their legal release from custody on bail. The system and method assists the incarcerated individual to access his or her own cash accounts and credit, or the cash and credit of friends, family and associates, in order to effectuate a bail payment.

### CROSS-REFERENCE TO RELATED APPLICATION

This application is a continuation of U.S. Non-Provisional application Ser. No. 16/188,538, filed Nov. 13, 2018, which claims priority to U.S. Non-Provisional application Ser. No. 15/253,058, filed Aug. 31, 2016, which claims priority to U.S. Non-Provisional application Ser. No. 12/982,500, filed Dec. 30, 2010, which claims the benefit of U.S. Provisional Application Ser. No. 61/308,075, filed Feb. 25, 2010, which are expressly incorporated by reference herein.

### BACKGROUND AND SUMMARY OF THE DISCLOSURE

The present disclosure relates to a user-focused system and method of Government Payment Service, Inc., dba GOVPAYNET® (“GovPayNet”) for use in the pretrial release field to be used primarily for assisting incarcerated individuals to explore, understand and expedite various options for their legal release from custody. Chief among these options is assisting the incarcerated individual to access his or her own cash accounts and credit, or the cash and credit of friends, family and associates, in order to effectuate a cash bail payment by credit cards, debit cards, and electronic checks. The system and method of an illustrated embodiment of the present disclosure uses data processing, payment industry, telecommunication and social media technologies to bridge the gaps that presently exist between many inmates awaiting trial who are approved for release by the courts and the sources of funds or programs that could help obtain those inmates' release. Delayed release of such inmates results in higher costs to society for unnecessary incarceration and a loss of freedom for individuals who otherwise would be released.

In one illustrated embodiment of the present disclosure, a method is provided for facilitating release of an inmate incarcerated by a governmental agency. The agency has an agency computer and an agency video communication system. The method includes receiving information over a communication network from an agency computer with a computing device. The information includes inmate and agency identification information, contact information for at least one potential payor, and information related to monetary obligations owed by the inmate before legal release of the inmate from the agency is available. The monetary obligations illustratively include at least one of a bail amount, a bond amount, fines, fees, tickets, child support, and penalties owed by the inmate. The method also includes calculating with the computing device a target balance payment necessary for release of the inmate from the agency on bail, receiving video communication data from the agency video communication system with a second video communication system, and transmitting video communication data from the second video communication system to the agency video communication system to establish a video communication session between the inmate and a release expeditor. The method further includes establishing a communication session between the release expeditor and at least one potential payor for payment of at least a portion of the target balance, transmitting at least one of credit card, debit card, or other payment information received from a payor from the computing device to a payment transaction authorization processor over the communication network, receiving a confirmation of approval for payment of at least a portion of the target balance from the payment transaction authorization processor at the computing device, and transmitting electronic notification from the computing device to the agency computer over the communication network indicating that the target balance for release of the inmate has been met.

In an exemplary embodiment, the method further includes charging an additional fee with the computing device and including the additional fee in a proposed payment amount transmitted from the computing device to the payment transaction authorization processor for approval so that the target balance is achieved without any charge to the agency for the payment services.

In another illustrated embodiment of the present disclosure, a method is provided for facilitating release of an inmate incarcerated by a governmental agency. The agency has an agency computer. The method includes receiving information over a communication network from an agency computer with a computing device. The information includes inmate and agency identification information, contact information related to a plurality of potential payors, and information related to monetary obligations owed by the inmate before legal release of the inmate from the agency is available. The monetary obligations illustratively include a bail amount, a bond amount, fines, fees, tickets, child support, and penalties owed by the inmate. The method also includes calculating with the computing device a target balance payment necessary for release of the inmate from the agency on bail, and automatically contacting at least one of the potential payors with the computing device using the contact information received from the agency computer to solicit payment of at least a portion of the target balance. The method further includes transmitting credit, debit, prepaid card or device information received from the payor from the computing device to a payment transaction authorization processor over the communication network, receiving a confirmation of approval for payment of at least a portion of the target balance from the payment transaction authorization processor at the computing device, and transmitting electronic notification from the computing device to the agency computer over the communication network indicating that the target balance for release of the inmate has been met.

In yet another illustrated embodiment of the present disclosure, a method is provided for facilitating release of an inmate incarcerated by a governmental agency by collecting payment of a target balance necessary for release of the inmate from the agency on bail. The method includes receiving information from an agency computer with a computing device. The information includes inmate identification, agency identification information and information related to monetary obligations owed by the inmate before legal release of the inmate from the agency is available. The monetary obligations illustratively include at least one of a bail amount, a bond amount, fines, fees, tickets, child support, and penalties owed by the inmate. The method also includes calculating a target balance payment necessary for release of the inmate from the agency on bail. The target balance is calculated by the computing device from the monetary obligation information received from the agency computer. The method further includes creating a web page with the computing device, displaying the inmate identification information and the target balance on the web page, permitting access to the web page for the inmate by a plurality of payors, and accepting a plurality of electronic payments from payors via the web page with the computing device. The method still further includes storing a total amount of payments received from payors for the inmate in a memory of the computing device, determining with the computing device when the target balance is met based on the stored total amount of payments received, and transmitting notification from the computing device to the agency computer when the target balance is received.

In an illustrated embodiment, the method further includes electronically receiving a plurality of payments from the plurality of payors, and sending the target balance to the agency electronically after the target balance is received. In an illustrated embodiment, the also includes charging an additional fee with the computing device so that the target balance is achieved without any charge to the agency for the payment services, receiving an electronic payment including the payment to be applied toward the target balance and the additional fee and transmitting an electronic payment, less the additional fee, to the agency.

In a further illustrated embodiment of the present disclosure, a method is provided for facilitating release of an inmate incarcerated by a governmental agency. The agency has an agency computer. The method includes providing a card swipe device to the agency. The card swipe device is programmed to automatically communicate with the agency computer. The method also includes receiving information over a communication network from an agency computer with a computing device. The information includes inmate and agency identification information, credit/debit card information from the card swipe device, and a proposed payment amount to be applied toward a target balance due to permit release of the inmate from the agency on bail. The method further includes transmitting the credit, debit, prepaid card or device information and the proposed payment amount from the computing device to a payment transaction authorization processor via the communication network, receiving an approval for payment of the proposed payment amount from the payment transaction authorization processor with the computing device, and sending confirmation of approval of payment of the proposed payment amount from the computing device to the agency computer.

In one illustrated embodiment, the agency releases the inmate on bail based on the notification from the computing device, before actual payment of the target balance is received by the agency. The method also includes receiving an electronic payment of the proposed payment amount from the payment transaction authorization processor and transmitting an electronic payment of the proposed payment amount to the agency. In an illustrated embodiment, the method includes charging an additional fee with the computing device and including the additional fee in the proposed payment amount transmitted from the computing device to the payment transaction authorization processor for approval so that the target balance is achieved without any charge to the agency for the payment services.

Additional features of the present system will become apparent to those skilled in the art upon consideration of the following detailed description of illustrative embodiments exemplifying the best mode of carrying out the present system as presently perceived.

### BRIEF DESCRIPTION OF THE DRAWINGS

The foregoing aspects and other features of this present system will become more readily appreciated and better understood by reference to the following detailed description when taken in conjunction with the accompanying drawings in which:

FIG. 1 is a block diagram illustrating of an illustrated embodiment of the present disclosure in which a release expeditor provides for-profit pretrial release services for a defendant;

FIG. 2 is a block diagram illustrating components a system of one illustrated embodiment of the present disclosure for managing incarcerated populations through automated pretrial release services including electronic bail, fine and fee payments;

FIG. 3 illustrates an agency computer coupled to a memory, a plurality of output devices, and a plurality of input devices;

FIG. 4 illustrates a GovPayNet computing device coupled to a memory, a plurality of output devices, and a plurality of input devices;

FIG. 5 is a flow chart illustrating steps performed by one embodiment of the system and method of the present disclosure for automated electronic payment of bail, fines and/or other fees using a card swipe device coupled to the agency computer;

FIG. 6 is a payment processing model for the system and method of the present disclosure;

FIGS. 7 and 8 are flow charts illustrating steps performed by another embodiment of the system and method of the present disclosure for managing incarcerated populations through automated pretrial release services including electronic bail, fine and fee payments;

FIG. 9 is an illustrative screen shot displayed on a display and used by a release expeditor to manage a communication session using the GovPayNet computing device;

FIG. 10 is an illustrative screen shot for a web payment portal of the present disclosure; and

FIG. 11 is a flow chart illustrating an embodiment of the system and method of the present disclosure which provides a “self-service” option for accumulating funds over time via a web payment portal, without a release expeditor's involvement.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the present system to the precise form disclosed in the following detailed description. Rather, the embodiments are chosen and described so that others skilled in the art may utilize their teachings. Therefore, no limitation of the scope of the claimed system is thereby intended. The present system includes any alterations and further modifications of the illustrated devices and described methods and further applications of the principles of the present system which would normally occur to one skilled in the art to which the present system relates. Corresponding reference characters indicate corresponding parts throughout the several views.

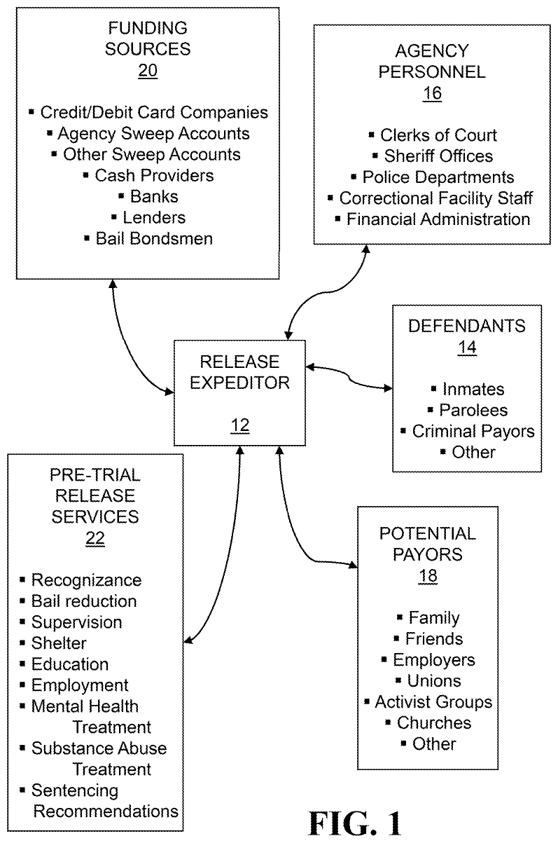

In an illustrated embodiment of the present disclosure, a system and method is disclosed for providing for profit pretrial release services to a defendant. As illustrated in FIG. 1, a trained pretrial release specialist or release expeditor 12 works with defendants 14 and agency personnel 16 to provide the pretrial release services. In an illustrated embodiment, the defendants 14 are incarcerated inmates who have been granted bail but have not yet paid the bail, for example. In other embodiments, the defendants 14 are parolees, criminal payors, or other individuals in need of services. The release expeditor 12 communicates with the defendants via video, audio, or computer communication sessions as described below. Release expeditor 12 assists the defendants 14 with various pretrial options available in relevant jurisdictions. The release expeditor 12 works with agency personnel 16 including clerks of court, sheriffs' office personnel, police department personnel, correctional facility staff, financial administration personnel or the like to facilitate release of the defendants 14.

As discussed in detail below, the release expeditor 12 works with potential payors 18 who might be able to assist in paying the bail, bond or other monetary obligations necessary to obtain release of the defendant 14. Release expeditor 12 processes payments from the payors 18 via computer, phone, and/or card readers to facilitate payment. The system also includes a web payment portal accessible by the potential payors 18 without direct involvement of the release expeditor 12. The potential payors 18 include family members, friends, employers, unions, activist groups, churches, or others interested in assisting the defendant 14 with release from an agency.

In addition to the potential payors 18, the release expeditor 12 works with various other funding sources 20 which may provide funds to permit release of the defendant 14. For example, funding sources 20 include credit/debit card companies, agency or other sweep accounts such as commissary accounts or parolee accounts, cash providers, banks, lenders and bail bondsmen. As discussed below, if the defendant 14 and other potential payors 18 are unable to raise the funds necessary to release the defendant 14, the release expeditor 12 facilitates communication between defendants 14 and the funding sources 20. Release expeditor 12 processes payments from the funding sources 20 and provides notification and payment to the agency for release of the defendant 14.

The release expeditor 12 may also refer the inmate to and facilitate contact with other sources which can perform other pretrial release services for the inmate as illustrated at block 22. Illustrative examples of such other pretrial services include recognizance, bail reduction, supervision, shelter, education, employment, mental health treatment, substance abuse treatment, and sentencing recommendations.

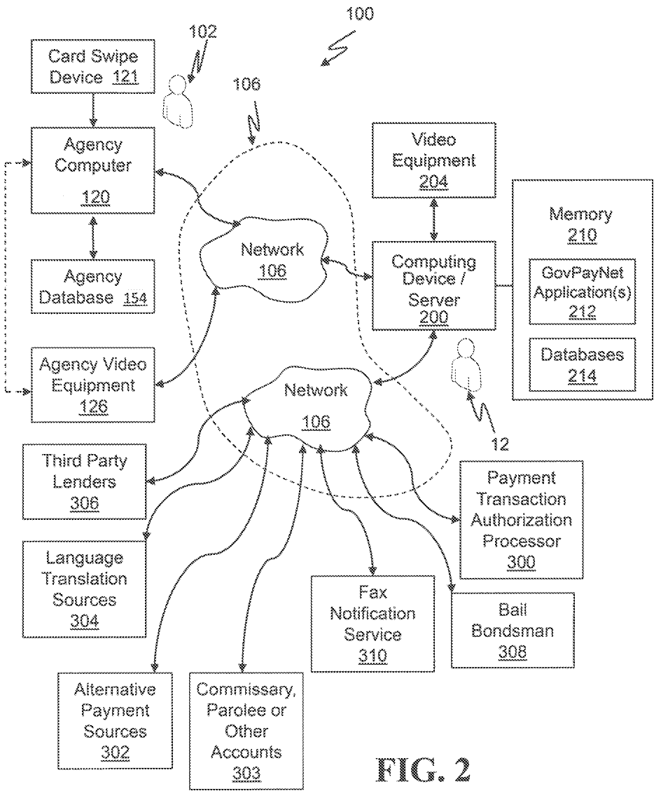

FIG. 2 illustrates a system 100 for managing incarcerated populations through automated pretrial release services including electronic bail, fine and fee payments. In the illustrated system 100, an agency computer 120 communicates with a GovPayNet computing device or server 200 through an electronic communication network 106. Reference number 120 used herein refers to any of a plurality of agency computers which are operated by a governmental agency. For example, computer 120 may be a general purpose computer or a portable computing device. Although agency computer 120 is illustrated as a single computer, multiple computing devices may be used together, such as over a network or other methods of transferring data. Exemplary computing devices include desktop computers, laptop computers, personal data assistants (“PDAs”), cellular devices such as smart phones, tablet computers, or other devices capable of the communications discussed herein.

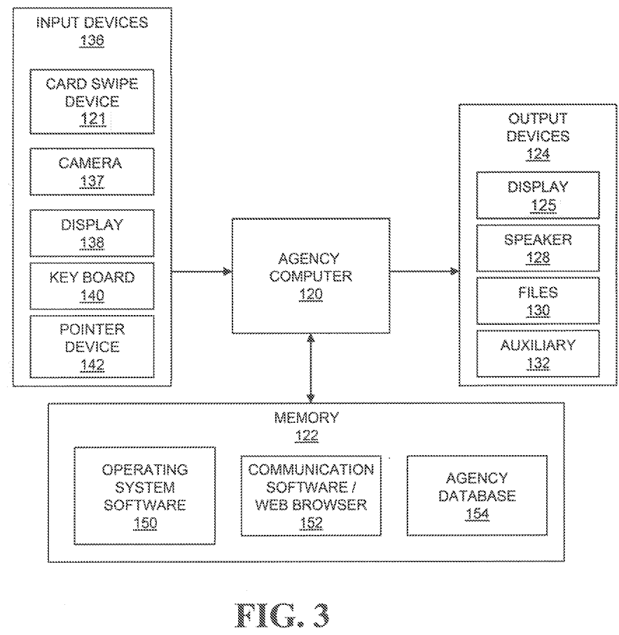

As shown in FIG. 3, computer 120 has access to a memory 122. Memory 122 is a computer readable medium and may be a single storage device or multiple storage devices, located either locally with computer 120 or accessible across a network. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (“DVD”) or other optical disk storage, magnetic cassettes, magnetic tape, magnetic disk storage or other magnetic storage devices, or any other medium which can be used to store information and which can be accessed by the computer 120.

Computer 120 also has access to one or more output devices 124. Exemplary output devices 124 include a display 125, a speaker 128, a file 130, and an auxiliary device 132. Exemplary auxiliary devices 132 include devices which may be coupled to computer 120, such as a printer, for example. Files 130 may have various formats. In one embodiment, files 130 are formatted for display by an Internet browser, and may include one or more of HyperText Markup Language (“HTML”), or other formatting instructions. In one embodiment, files 130 are files stored in memory 122 for transmission to another computer and eventual presentation by another output device or to at least to influence information provided by the other output device.

Computer 120 also has access to one or more input devices 136. Exemplary input devices 136 include a card swipe device 121, camera 137, a display 138 (such as a touch display), keys 140 (such as a keypad or keyboard), a pointer device 142 (such as a mouse, a roller ball, a stylus), and other suitable devices by which an operator may provide input to computer 120.

Memory 122 illustratively includes operating system software 150, communications software 152, and an agency database 154. Exemplary communications software 152 includes e-mail software, Internet browser software, and other types of software which permit computer 120 to communicate with other computing devices across a network 106. Exemplary networks include a local area network, a cellular network, a public switched network, and other suitable networks. An exemplary public switched network is the Internet.

Referring to FIG. 2, system users 102 are shown with an associated computer 120. The user 102 is typically an agency representative. However, an inmate may use certain features of computer 120. A given user 102 may have multiple computing devices 120 through which the user 102 may access a computing device 200. Some agency computers 120 communicate with GovPayNet computing device 200 through a public switched network, such as the Internet, while other agency computers 120 communicate with computing device 200 through a cellular network. In one embodiment, such cellular service may be provided through a connection to the Internet.

Computing device 200 is labelled as Computing Device/Server because it serves or otherwise makes available to the agency computer 120 various applications, information, products or services. In one embodiment, computing device 200 is a web server and the various applications are web sites which are served by computing device 200. Although a single server 200 is shown, it is understood that multiple computing devices are often implemented to function as the illustrated server 200.

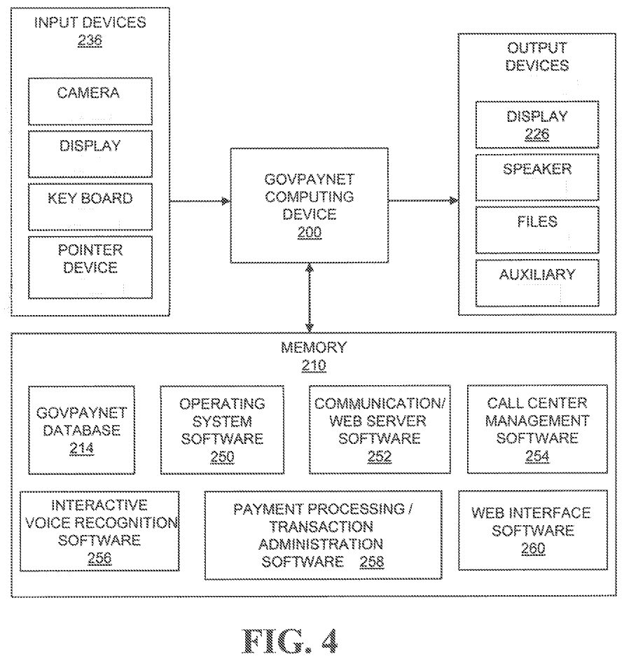

Computing device 200 has access to a memory 210 as shown in FIGS. 2 and 4. Memory 210 is a computer readable medium and may be a single storage device or multiple storage devices, located either locally with computing device 200 or accessible across a network. Computer-readable media may be any available media that can be accessed by the computing device 200 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store information and which can be accessed by the computing device 200.

In addition to one or more GovPayNet software applications 212, memory 210 stores one or more databases 214 which are used by the applications 212. Software applications 212 stored in memory 210 illustratively include operating system software 250 and communication software 252 which includes account and access management applications. Exemplary communications software 252 also includes e-mail software, web server software, and other types of software which permit server 200 to communicate with computing devices 120 across the network 106.

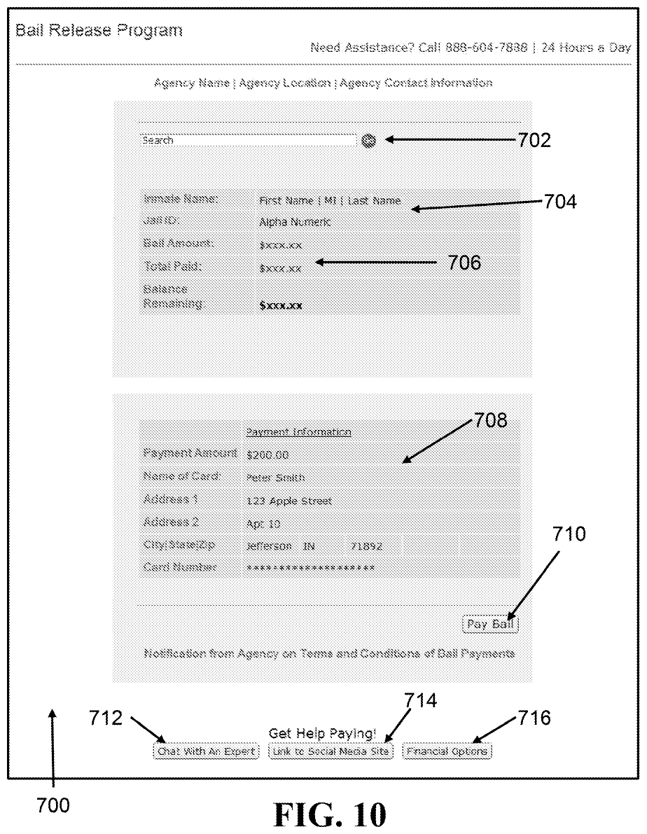

The software applications 212 stored in memory 210 also includes, referring to FIG. 4, call center management software 254, interactive voice recognition (IVR software 256, payment processing software 258, and web interface software 260. The call center management software 254 and interactive voice recognition software 256 provide automatic messaging services in a conventional manner as discussed herein. Payment processing software 258 illustratively receives credit card, debit card or other payment information and communicates with a payment transaction authorization processor 300 shown in FIG. 2 as discussed in more detail herein. Therefore, the payment processing software 258 transmits credit card or debit card information received from a funding source to the payment transaction authorization processor 300 over communication network 106 and receives confirmation of approval for payment from the payment transaction authorization processor 300 via the network 106. The payment processing software 258 then transmits electronic notifications from computing device 200 to payers and to the agency computer 120 as discussed herein. The web interface software 260 generates a web payment portal, shown, for example in FIG. 10 for receiving payments on behalf of an inmate incarcerated by the governmental agency from alternative payment sources 302 or from the inmate's other accounts such as a commissary account, parolee account or other account as shown at block 303 in FIG. 2.

FIG. 2 also illustrates that a release expeditor 12 may use computing device 200 to provide communication between an inmate located at the agency and a language translation source 304, a third party lender 306, or a bail bondsman 308. The release expeditor 12 also communicates with the alternative payment sources 302. The language translation sources 304 facilitate communication between the inmate and the release expeditor 12, third party lenders 306 or bail bondsmen 308.

As shown in FIG. 2, the present disclosure includes a card swipe device 121 configured to be coupled to each agency computer 120. In an illustrated embodiment, the card swipe device 121 is a MiniMag™ compact intelligent magstripe swipe reader available from IDTECH located in Cypress, Calif., the specifications of which are incorporated herein by reference. Illustratively, the card swipe device 121 is plugged into an USB port of the agency computer 120. The card swipe device 121 is programmed to retrieve information from a cardholder's credit or debit card and populate data fields on an input screen of the agency computer 120. The agency computer 120 then transmits the information over the communication network 106 to the computing device/server 200. In another embodiment, an IPHONE®, or other suitable smart phone or PDA, equipped with a magnetic stripe reader may be used as the computer 120.

In an illustrated embodiment of the present disclosure, the governmental agency has video equipment 126 to provide an audio/video communication session between the inmate located at the agency and the release expeditor 12. In one embodiment, the release expeditor 12 uses video equipment 204 that communicates through the computing device 200. Illustratively, the video equipment 126 and 204 may be separate dedicated video equipment or cameras coupled to or integrated with the agency computer 120 and the main computing device 200. The use of video equipment 126 and 204 facilitates interaction between the inmate and the release expeditor 12 to meet the administrative needs of the agency and to facilitate obtaining release of the inmate on bail as discussed herein. The computing device 200 illustratively uses integrated interactive voice recognition (“IVR”), Internet Protocol video conferencing and Voice Over Internet Protocol (“VOIP”) received from audio and video interfaces located within agency facilities and connected to secure, centralized computing device 200 via the communication network 106. Such communication sessions are dynamically bridged for payment sessions of balances due between inmates 14, release expeditors 12 and potential payors 18.

As discussed above, an illustrated embodiment of the present disclosure enables payments to agencies by establishing a file in a data processing system through the Internet or other suitable communication link 106 from the agency's computer 120 to the GovPayNet computing device 200. The information necessary to establish this file is obtained when the inmate or other cardholder making the payment swipes a credit card or debit card in the card reading device 122 attached as a peripheral to an agency computer 120.

The card swipe device 122 of the present disclosure does not require an independent power source or telecommunications capability. Instead, the present system relies on power and telecommunications that support existing agency hardware. With no moving parts, screen or keypad, the card swipe devices 122 are highly reliable. If replacement is necessary, a new device 122 is shipped overnight by any express mail service.

In processing the payment, computing device 200 interacts with credit and debit card companies for payment execution through the payment transaction authorization processor 300. The agency computer 120 uses the card reader 122 to provide data to the computing device 200 through a web link or other communication network 106. Typically, the agency has agreed to accept the cardholder's payment from the payment service provider (i.e., GovPayNet) operating the computing device 200. The payment service provider conducts interaction with the credit card and/or debit card company on the cardholder's behalf, receives payment electronically from the card system, and issues this payment to the agency. The payment service provider charges a fee to the cardholder for this service, which is added to the payment amount.

In one illustrated embodiment, the system and method of the present disclosure is used by law enforcement departments such as municipal and county jails and quasi-law enforcement departments such as public automobile impound lots. In particular, the present system expedites the payment of bail by defendants who have been granted bail by a court. One embodiment of the present system makes it unnecessary for defendants to find and make arrangements with a bail bond service, have a check or sufficient cash on their person to make an immediate cash bail payment, or have funds brought or sent to the agency by a family member, friend or associate. The inmate or family member, friend or associate (cardholder) is only required to have a major credit card or debit card and a credit or cash balance sufficient for the bail amount and the fee that the payment service provider charges the cardholder for its services.

For a law enforcement agency, the present system simplifies and improves the process of collecting bail from a defendant. To utilize the present system, the agency needs a computer 120 and Internet connectivity. A bank account is also necessary for the agency to receive funds from the payment service provider electronically. Using the present system to facilitate credit card, debit card or other types of payments allows the agency to avoid cumbersome procurement and managerial processes involved in contracting with a major card company directly or with an intermediary card acceptance company. Using the present system also allows the agency to avoid the burden of complying with card association rules that govern all aspects of card acceptance by an authorized merchant, from proper signage to resolving cardholder disputes, as the agency is not acting as a card-accepting merchant.

In some jurisdictions, a change in law may be necessary to enable government offices to impose any charge above the payment amount. The present system, however, makes legislative and regulatory change unnecessary, as the service fee the cardholder pays to payment service provider is not a convenience fee charged by the agency. As the cardholder bears the expense of the payment service provider's service, the present system can be deployed at no cost to the agency.

Agency personnel using the present system receive an almost immediate transaction acceptance or denial message from computing device 200. Computing device 200 transmits a message to the agency's computer 120 based on a response the computing device 200 receives from the processor 300 in response to a request for authorization of the transaction. The system can additionally accept split tenders, dividing transaction amounts between or among multiple cards and supports an agency that enables partial payment by card and by check, cash or money order as discussed below. Actual payment occurs subsequent to the transaction through a daily settlement process between the agency and the payment service provider. Agency management personnel may, however, choose to rely on the payment service provider's message that a bail transaction has been authorized for payment and release the inmate in advance of settlement payment.

The agency's use of the card swipe embodiment of the present system begins when an inmate or another cardholder acting on an inmate's behalf posting bail or a cardholder paying a fine or fee presents the agency representative 102 with the information necessary to identify the matter, such as a case number, ticket number, date, or other identifying information and the amount due. The cardholder presents a major credit card or debit card (or other suitable payment type) to the representative 102, who swipes the card through the card reader 122 connected to the agency's computer 120. The card reader swipe device 122 accesses data in certain fields in the card's magnetic stripe to populate corresponding data fields in an input screen displayed on computer 120. An illustrative display screen 700 is shown in FIG. 10. If the card was issued from a bank outside of the U.S., the clerk uses a pull-down feature to identify the country of card issuance. Depending on the country of issuance, the present system's programming may cause a replacement screen to appear, modified to meet the card operating rules applicable in that country. In an illustrated embodiment, the representative 102 enters the transaction amount, identifies the type of transaction (i.e., “$500, Bail”), swipes the card using the card reader swipe device 122, and then enters the Card Verification Value (“CVV”) found on the card's reverse side.

In this way, the present system reduces the laborious and error-prone task of manually entering the card number, expiration date, cardholder's name and other necessary data. The accuracy of data entered automatically is ensured because the information is drawn directly from the related fields on the card's magnetic stripe. Also, the agency's transaction processing burden is reduced to entering the transaction type, transaction amount and CVV. This provides for a more accurate process and increases overall transaction speed.

Once all data fields are populated, the clerk will click “send” and the present system will route the cardholder's information and processing codes assigned in advance to the agency to identify the agency and the transaction type. This establishes a record of the cardholder and the transaction on the computing device 200. In other embodiments of the present system, the agency's system and the payment service provider's system are integrated so that data files on the agency's system and the payment service provider's system are interactive and updated simultaneously.

Computing device 200 then sends a credit or debit transaction authorization request to the identified card company's payment transaction authorization processor 300 shown in FIG. 2. This results in a transaction approval or denial message being routed back from the card-issuing bank, through the payment transaction authorization processor 300 to computing device 200, with the message appearing on the agency's computer 120 display screen. If payment is authorized, the response to the agency computer 120 includes a printable receipt. The entire process, from initial sending to final response, takes roughly the same time as a typical credit card or debit card retail authorization. Upon receipt of the authorization or denial, the agency representative 102 acts accordingly. In a law enforcement environment, the agency may elect to release a defendant on the basis of a transaction authorization being returned through the system even though actual payment is made later through an end-of-day settlement cycle.

Payment of funds from the cardholder's account to the agency is made after the completion of an end-of-day settlement cycle between the agency and the payment service provider. In an integrated agency environment, the agency's system and the payment service provider's system interact to compare transaction details and totals for the concluded processing day. In a non-integrated environment, the payment service provider's daily transaction report is sent in an electronic file, e-mailed, or sent by fax through a fax notification service 310. Non-integrated agencies typically perform a manual reconciliation of their daily transaction information against the payment service provider's file data.

Whether the reconciliation is manual or automatic, the agency identifies errors and exceptions to the payment service provider for later resolution, and confirms accurate transactions to the payment service provider. For transactions reported as accurate by the agency, the payment service provider completes a periodic capture process with the card-issuing bank, and draws from these funds to send payment to the agency. The payment service provider's funds transfer to the agency is controlled by the preprogrammed codes assigned to identify the agency and transaction type. These codes can be used by the agency for further instructions, such as specifying payment method (Automated Clearinghouse (“ACH”), wire transfer, check) or specifying different agency bank accounts for different types of payments.

The present system is hardware-neutral and operating system-neutral giving it flexibility of use. As discussed above, the present system or method allows connection of a card swipe device 122 to any computer 120 using a suitable operating system 150. The card swipe device 122 may be used with any computer 120 that can access the Internet or other communication network 106. The agency computer 120 serves as a bridge to computing device 200. Data processing by the agency's computer 120 is not required to complete the transaction. This flexibility also allows the present system to be used in some embodiments with wireless devices, provided the device being used has Internet connectivity and screen and keyboard or keypad capability. Therefore, in certain embodiments the present system is used on a remote or mobile basis, such as in patrol cars, patrol boats, or extremely rural agency locations where other forms of telecommunication are difficult. For security, the present system includes end-to-end encryption via Transport Layer Security (“TLS”). In some embodiments, the present system can be modified to support emerging card technology, including handheld devices, smart cards and Remote Frequency Identification (“RFID”) contactless cards, for example. In some embodiments, the present system is used by an agency that is not engaged in law enforcement or quasi-law enforcement, but is providing other public services, such as licenses and permits, or collecting public revenue such as taxes, civil fines or assessments.

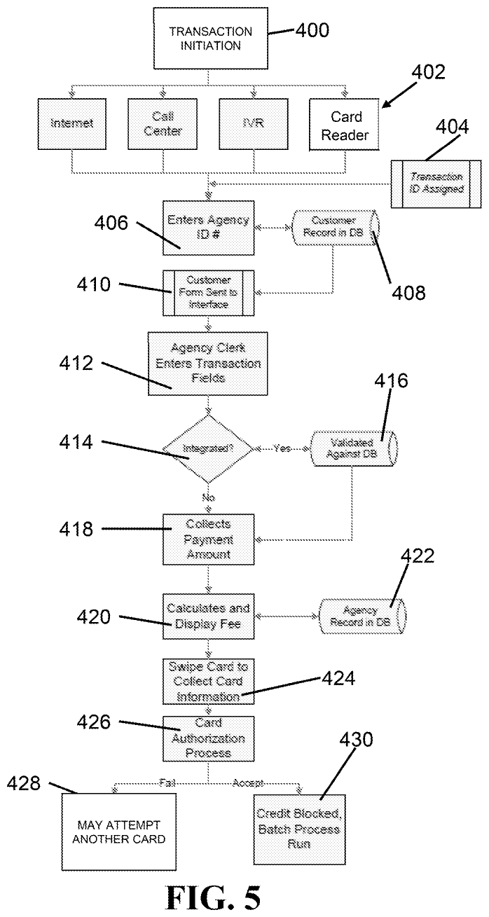

FIG. 5 is a flowchart illustrating the steps performed during implementation of one embodiment of a method of the present invention. Referring to FIG. 5, the agency representative 102 accesses the agency computer 120 as illustrated at block 400. The agency personnel 102 may receive assistance through various interfaces 402 including the Internet, a call center, interactive voice recognition, or a card reader connected to an agency terminal. In an illustrated embodiment, the agency representative 102 accesses a website and receives a web page from computing device 200 via the communication network 106.

A transaction identification number is assigned by computing device 200 as illustrated at block 404. Next, the representative 102 enters an agency identification number as illustrated at block 406. The agency identification number is received by computing device 200 which accesses the agency's records in database 214, as illustrated in block 408. An appropriate form is sent as a web page or other interface from computing device 200 to agency computer 120 as illustrated at block 410. The representative 102 then enters transaction fields such as identifying the particular inmate as illustrated at block 412. If the agency computer 120 and computing device 200 are integrated as illustrated in block 414, the data is validated against the agency data in database 214 as illustrated at block 416. If the agency computer 120 and computing device 200 are not integrated, a payment amount is entered, as illustrated in block 418 and sent to computing device 200 via the communication network 106.

Computing device 200 calculates the total fee amount due, including the transaction fee as illustrated at block 420. Again, computing device 200 accesses agency records in database 214 as illustrated at block 422, if available. Next the operator or inmate swipes the credit or debit card through card swipe device 122 as illustrated at block 424. The information read by the card swipe device 122 populates data fields in the form which is transmitted from the agency computer 120 to the computing device 200. Computing device 200 completes the card authorization process as illustrated at block 426 by sending and receiving information to the payment transaction authorization processor 300 in a conventional manner. If the card authorization process fails at block 426, the payor or inmate may attempt another card as illustrated at block 428. If the card authorization process is accepted at block 426, a credit is blocked and a batch process is run as illustrated at block 430.

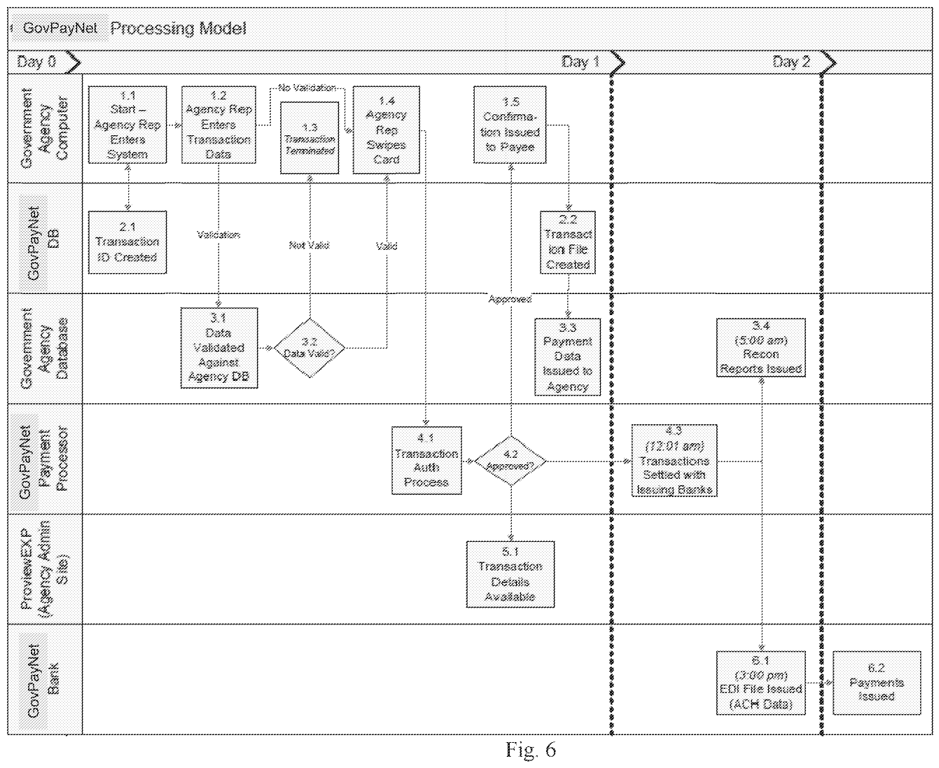

FIG. 6 illustrates and exemplary processing model showing timing of processing transactions using the system and method of the present disclosure. Referring to FIG. 6, when the agency representative 102 accesses the payment application provided by computing device 200 on agency computer 120 as illustrated at block 1.1, the transaction ID is created by computing device 200 and stored in database 214 as illustrated at block 2.1. The agency representative then enters the transaction data on computer 120 as illustrated at block 1.2. The entered data is validated against the agency database by computing device 200 accessing database 214 as illustrated at block 3.1. Computing device 200 then determines whether the data is valid at block 3.2. If the data is not valid, the transaction is terminated and notification is provided to agency computer 120 as illustrated at block 1.3. If the data is valid at block 3.2, the agency representative 102 swipes the card through card swipe device 122 as illustrated at block 1.4.

Upon receipt of the card information at computing device 200, payment processing software 258 is executed by computing device 200 to begin the transaction authorization process as discussed above and illustrated at block 4.1. If the transaction is approved at block 4.2, a confirmation is issued to the payee by a message sent to agency computer 120 as illustrated at block 1.5. Transaction details are available as illustrated at block 5.1. Once the confirmation is issued to the payee at block 1.5, a transaction file is created by computing device 200 as illustrated at block 2.2. Payment data is then issued to the agency computer 120 as illustrated at block 3.3.

The next day, transactions are settled with issuing banks as illustrated at block 4.3. Reconciliation reports are then issued at block 3.4 and an EDI file is issued including ACH data at block 6.1. The following day, payments are issued as illustrated at block 6.2.

In many instances, the incarcerated inmate will not have a credit card or debit card or will not have enough credit available to pay the bail and other expenses required to release the inmate from the governmental agency. In these instances, the payment service provider provides a trained release expeditor 12 to assist the inmate with the release process. The present system and method facilitates collection of monetary obligations owed by the inmate before legal release of the inmate from the agency is available. Such monetary obligations include at least one of a bail amount, fines, fees, tickets, child support, and various civil or criminal monetary obligations and penalties.

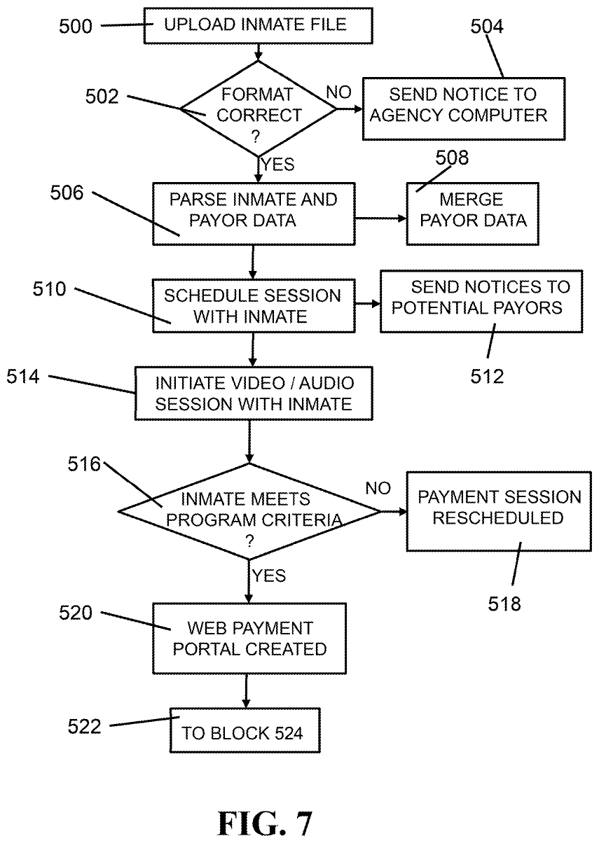

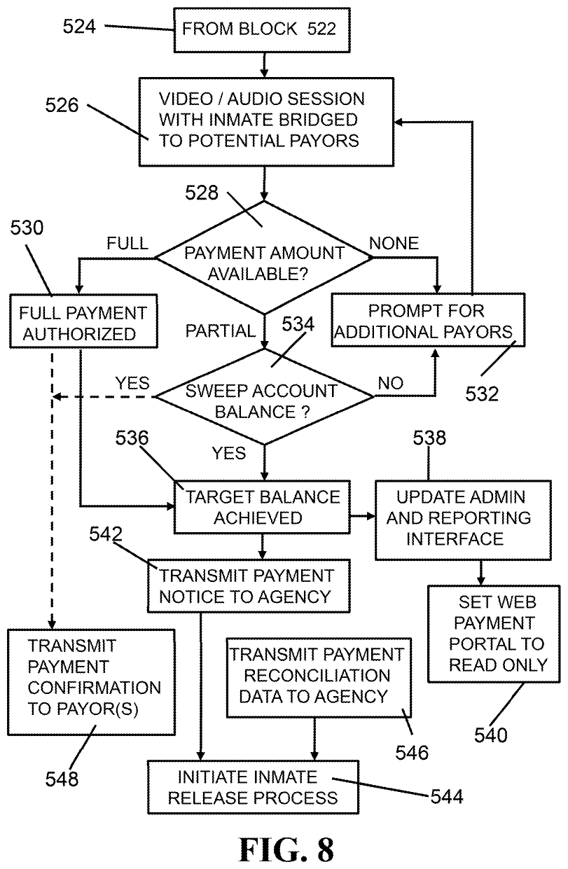

FIGS. 7 and 8 illustrate another embodiment of the present disclosure for managing incarcerated populations through automated pretrial release services including collecting electronic bail fine and fee payments from a plurality of different payment sources to permit release of the inmate from the agency. Referring now to FIG. 7, a file is uploaded from the agency computer 120 to the computing device 200 via the communication network 106. The uploaded file includes data input by the agency representative 102 during an intake process for the inmate. In illustrated embodiments, the file includes the inmate's name, a jail or agency identification, an amount due for bail or other monetary obligations as discussed herein and contact information for potential payors of the monetary obligations. The contact information for the potential payors preferably includes telephone number, e-mail address, a short message service (“SMS”) number or social media information such as FACEBOOK® pages and TWITTER® account information, for example.

In illustrative embodiments, the inmate file further includes scheduling information, such as times that the inmate is available for a release communication session with the release expeditor 12. The inmate file also includes a unique identification for the particular agency. The inmate file is illustratively uploaded via a conventional secured file transfer protocol (“FTP/S”) in an automated batch received by the payment service provider's computing device 200 from the agency computer 120. Computing device 200 determines whether the inmate files are in the correct format at block 502. If not, the computing device 200 sends a notification to the agency computer 120 of the incorrect format as illustrated at block 504. If the format is correct at block 502, the computing device 200 parses the inmate data and potential payor data into a database 214 which is illustratively a SQL database as illustrated at block 506. Potential payor data for the inmate is merged with other data in a historical data record in the database 214 as illustrated at block 508. Therefore, computing device 200 contains potential payor contact information in database 214 for future reference in connection with the inmate.

Next, computing device 200 generates a schedule for a release management communication session between the inmate and the release expeditor 12 as illustrated at block 510. Computing device 200 uses scheduling information received in the inmate file uploaded at block 500, if such scheduling information is available. The computing device 200 transmits the schedule to agency computer 120 through communication network 106. In addition, computing device 200 sends notices to potential payors as illustrated at block 512. Illustratively, the computing device 200 sends an interactive voice recognition message to potential payors automatically using phone numbers received in the uploaded inmate file. The message sent to the potential payors advises the payors that the release expeditor 12 will be contacting the potential payor at a certain time as set forth in the release management session schedule generated at block 510. Alternatively, computing device 200 sends an e-mail or text message to the potential payors indicating that the release expeditor 12 will contact the potential payor to discuss possible release of an inmate from the agency at a particular time set forth in the schedule.

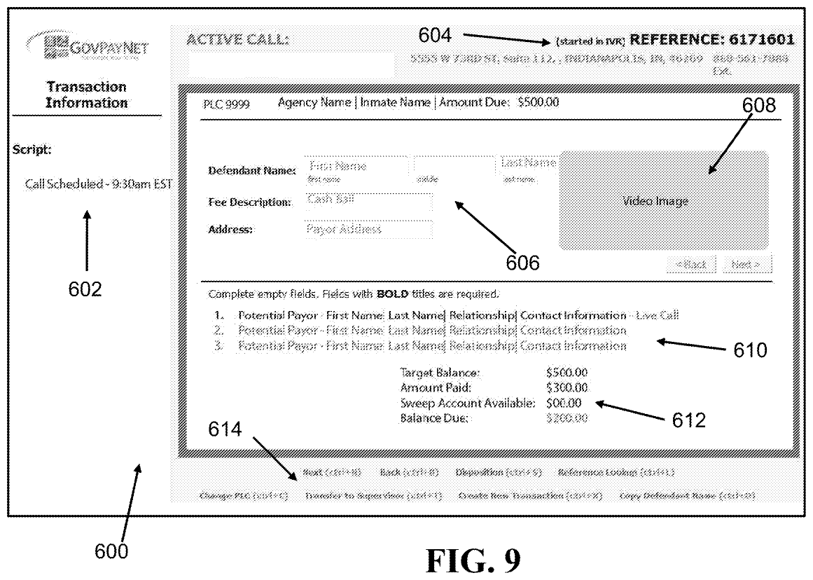

At the appropriate time, computing device 200 initiates a video and audio release management session with the inmate as illustrated at block 514. The release expeditor 12 uses a display screen, as shown, for example, in FIG. 9, displayed on the display 226 of computing device 200 during the communication session. Preferably, the inmate and the release expeditor 12 communicate via the video equipment 126 and 204.

The release expeditor 12 or the computing device 200 determines whether the inmate meets the program criteria as illustrated at block 516. For instance, if the inmate does not have any other potential payors, or potential payors are temporarily beyond reach, the inmate would not meet the program criteria. The inmate also may not meet the criteria for other reasons such as having access to the program denied to due to disciplinary issues or having availability interrupted due to a medical concern or other conflict such as an attorney meeting or interrogation.

If the inmate does not meet the program criteria at block 516, the payment session is rescheduled by computing device 200 as illustrated at block 518. If the inmate does meet the program criteria at block 516, a web payment portal is created by the computing device 200 as illustrated at block 520. The web payment portal is a website accessible by a plurality of potential payors as illustrated in FIG. 10. Computing device 200 advances to block 524 of FIG. 8 as illustrated at block 522. Next, the release expeditor 12 accesses the input and control screen shown in FIG. 9, for example, to initiate contact with potential payors as illustrated at block 526. In an illustrated embodiment, the inmate and video and audio session is placed “on hold” while the release expeditor 12 makes initial contact with the potential payors. By selecting an input on the display screen of computing device 200, computing device 200 automatically contacts the potential payor, preferably by automatically dialing the telephone number from database 214. Computing device 200 may then create a conference call between the inmate, the potential payor, and the release expeditor 12 in order to convince the potential payor to provide credit card, debit card or other payment information to the release expeditor 12 in order to pay the target balance owed by the inmate for release from the agency.

Next, the release expeditor 12 determines the payment amount available from the particular payor as illustrated at block 528. If no payment is available from the contacted payor, the release expeditor 12, or the computing device 200 prompts the contacted payor for any additional payors who may be able to help pay the target balance as illustrated at block 532. If additional payors are provided at block 532, the release expeditor 12 or the computing device 200 contacts those additional payors as illustrated at block 526. Payment is acceptable in a plurality of different payment types received by the computing device 200 including credit card, debit card, prepaid card payments, other credit, debit or prepaid device (i.e., phone, pda, or other device) payments, electronic funds transfer (“EFT”) payments, and electronically funded loans.

If full payment is available at block 528, computing device 200 indicates that full payment is authorized as illustrated at block 530. Therefore, the target balance for release of the inmate is achieved at block 536. If only a partial payment of the target balance is available at block 528, computing device 200 determines whether enough partial payments have been authorized or received in order to pay the target balance. Computing device 200 also monitors other “sweep” accounts to assist with payment of the target balance. Such other accounts illustratively include commissary accounts, parolee accounts or other credits or accounts of the inmate (see block 303 of FIG. 2). Computing device 200 may use funds available in these other accounts to satisfy a portion of the target balance. If the target balance is available through use of the “sweep” accounts combined with payments received from the inmate or other payors, computing device 200 sweeps the account balance from the payors, the inmate's account 303, or other sources as illustrated at block 534. If the target balance has not been reached at block 534, computing device prompts for additional payors at block 532. If the account balance is swept at block 534, then the target balance is achieved at block 536.

Computing device 200 updates an administration reporting interface as illustrated at block 538 and sets the web payment portal created at block 520 to read-only mode. Computing device 200 updates the web portal to show that the target balance has been reached and a confirmation is sent to the government agency computer 120 at a particular date and time. Therefore, interested parties accessing the web portal can determine that the bail was achieved for a particular inmate.

If the target balance is achieved at block 536, computing device 200 also transmits a payment notice or confirmation to the agency computer 120 as illustrated at block 542. As discussed above, the agency can use this confirmation to initiate the inmate release process as illustrated at block 544. The process can be started even before payment is made to the agency. The computing device 200 also transmits payment reconciliation data to the agency at the appropriate time as illustrated at block 546. Once either full payment is authorized from a single payor or from multiple payors, computing device 200 transmits payment confirmations to the payors as illustrated at block 548.

The computing device 200 may use the contact information for potential payors received in the inmate file to send messages to the potential payors along with a link to the web payment portal or the portal address if a message is sent via telephone. The computing device 200 also uses social media in another embodiment to direct potential payors to the web payment portal. For example, computing device 200 updates a Facebook page for the inmate to include a link or information regarding the web payment portal accessible by the inmate's friends on Facebook. Twitter messages could also be sent to identify the web payment portal and the need to collect money to achieve the target balance on behalf of the inmate.

As discussed above, the release expeditor 12 uses a display screen displayed on display 226 of computer 210 during the communication session with the inmate. As shown in FIG. 9, the display screen displays transaction information in area 602. In one embodiment, this information includes a list of scheduled calls. A reference number for the session is provided at location 604. Other information is provided in area 606, such as the inmate or defendant's name, a fee description, and an address for the payor. A video image of the inmate is provided in area 608.

A list of potential payors is provided at location 610 on screen 600. Target balance information, as well as the amount paid, sweep account available, and balance due information are provided at location 612. For example, the computing device 200 displays a difference between the total amount received on behalf of the inmate and the target balance to indicate how much more money needs to be collected to reach the target balance at location 612. Further controls for the release expeditor 12 are provided in region 614 of display screen 600. In an illustrated embodiment, the release expeditor 12 can click on a potential payor's name with an input device 236 of computing device 200 to automatically contact the potential payor, preferably via telephone. If additional funds are received from the payor, the amount paid or sweep account available balance is updated in section 612. The total amount of a balance due to achieve the target balance is also updated in section 612 of display screen 600.

Further details of the web payment portal 700 are shown in FIG. 10. The portal can be accessed by an agency representative 102 or by a potential payor via the Internet. In an illustrated embodiment, a search request may be entered at location 702. Illustratively, the searcher can look for an inmate's name or an agency/jail ID as indicated at location 704. Once the particular inmate is located, a bail amount, total amount paid, and remaining balance is shown at location 706 of the display screen 700. In other words, the display screen shows a difference between the total amount received on behalf of the inmate and the target balance at location 706 to indicate how much more money needs to be collected to reach the target balance.

Another region 708 of display screen 700 permits the payor to enter payment information in order to pay all or a portion of the target balance for the inmate. In an illustrated embodiment, the payor enters a payment amount, a name on the card, an address, and card number into region 708 and then clicks the “Pay Bail” button 710 to submit payment as discussed above. If a card reader 122 is coupled to the computer used by the payor, the card reader 122 automatically provides the card number in section 708.

The potential payor can communicate with an expert such as release expeditor 12 by clicking button 712. The payor can also link to a social media web site, such as Facebook or Twitter, for example, by clicking button 714. Additional financing options may be accessed by clicking button 716. Financial options 716 include third-party lenders 306 or bail bondsmen 308 as illustrated in FIG. 2. As discussed above, once the target balance has been achieved, the computing device 200 changes the web portal 700 to read only mode and provides an update in region 706 that the target balance has been achieved.

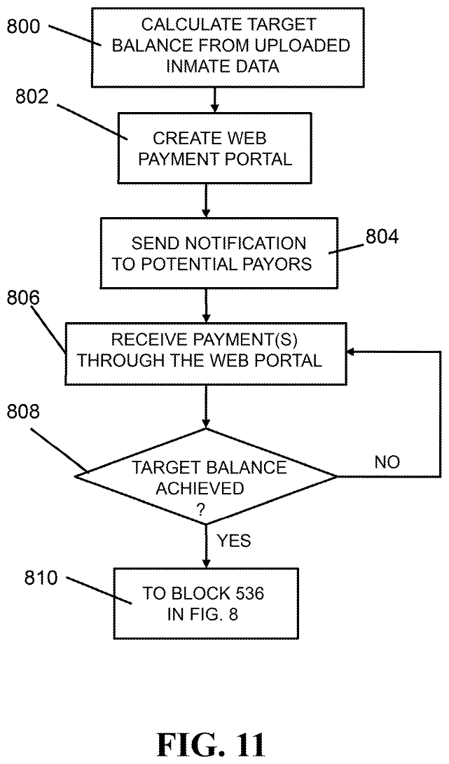

Additional details of the “self-service” option for payment of the target balance are illustrated in the flow chart of FIG. 11. As discussed above, computing device 200 calculates a target balance owed by the inmate from the uploaded inmate data as illustrated at block 800 of FIG. 11. Computing device 200 then creates a web payment portal at block 802 (see also block 520 in FIG. 7). FIG. 10 illustrates one embodiment of the web portal user interface display screen.

Computing device 200 then sends notification to the potential payors as illustrated at block 804 using the payor contact information uploaded from the agency computer 120 or received during the communication session with the inmate as discussed above. Such notification may include automated phone calls, e-mails, text messages, social media contacts or other communication to the potential payors.

Next, computing device 200 receives electronic payments from the payors through the web portal as illustrated at block 806. As discussed above, payments received through the web portal are processed by the computing device 200 through communication with the payment transaction authorization processor 300. Payment confirmations are transmitted to the payors from the computing device 200 via phone, e-mail, text message, or fax.

Computing device 200 determines whether the target balance has been achieved at block 808. If not, the web portal remains open to receive payments through the web portal at block 806. If the target balance has been achieved at block 808, computing device 200 proceeds as illustrated in block 810 to block 536 in FIG. 8 to provide notice to the agency at block 542 and to update the administration and reporting interface at block 538 and set the web payment portal to read only at block 540. As discussed above, the agency initiates the inmate release process at block 544 after receiving the notice at block 542 or after receiving payment reconciliation data at block 546.

As discussed above, the present disclosure relates to a user-focused system and method in the pretrial release field to be used primarily for assisting incarcerated individuals to explore, understand and expedite various options for their legal release from custody. Chief among these options is assisting the incarcerated individual to access his or her own cash accounts and credit, or the cash and credit of friends, family and associates, in order to effectuate a cash bail payment by credit cards, debit cards, and electronic checks. The system and method of an illustrated embodiment of the present disclosure uses data processing, payment industry, telecommunication and social media technologies to bridge the gaps that presently exist between many inmates awaiting trial who are approved for release by the courts and the sources of funds or programs that could help obtain those inmates' release. Delayed release of such inmates results in higher costs to society for unnecessary incarceration and a loss of freedom for individuals who otherwise would be released.

The system and method considers individual commitments of cash payments within a variable parameter. Other options include referrals to various governmental and not-for-profit pretrial release and recognizance programs, referrals to licensed providers of bail bond services, and referrals to or electronic integration with other sources of funds that may be used for posting bail including licensed lenders. The system may either operate independently or in combination with the assistance of a human operator, guidance from on-site personnel, or in a self-service mode using kiosks, IVR services, or by dedicated web sites.

The system and method of an illustrated embodiment of the present disclosure may be used by law enforcement departments and other public agency offices having a wide range of automation capabilities. In one embodiment, the system and method connects to an agency computer through an interface and an integrated system approach that permits automated file and data sharing. In another embodiment, the system and method is used with less technologically sophisticated agencies or departments using alternate methods of data transmission such as fax, email, or remote data entry by government personnel. In the case of less automated departments, especially those relying on paper records, the system and method can serve as a surrogate central database. The system and method also externalizes various accounting processes through its web-based platform, enabling service personnel to “close their cash drawers” at the end of the day faster and more accurately.

The system and method of an illustrated embodiment of the present disclosure is used for assisting public officials in charge of incarcerated populations with schedule management, and assisting public officials to enable an individual to pay obligations to a public authority or agency, including taxes, fees, fines, assessments and other obligations, by credit and debit card. The system and method uses automated telecommunication, financial, and data processing technologies to connect the incarcerated individual, initially to a subject-matter expert and process transactions through an intermediary system. Thus, the payment system and method does not require the involved government agency or office to accept debit cards or credit cards itself, directly.

The present system and method extends the ability of inmates to connect to those who may help in effectuating release. The system and method does this outreach automatically through automated phone calls, emails, social media feeds and other electronic postings or a human operator may initiate some or all of these contacts and social messaging on a manual basis in alternative embodiments. Thus, the system and method recognizes the profound level of societal changes brought about by the Internet and the explosion of personal communication devices that enable an unprecedented speed and flexibility in how people connect.

An illustrated embodiment of the present system and method includes an automated “fund raising” approach allowing the inmate, friends, families and other supporters to accumulate funds to be put towards the inmate's legal release by establishing a temporary, inmate-dedicated web site as a virtual destination for third parties to electronically direct funds to the inmate's benefit and accumulate funds toward payment of an inmate's bail, other fees and obligations, or to provide funds for use within a confinement facility for purposes such as commissary purchases or telephone calls which can also be allocated towards obtaining legal release.

This feature of the present system and method allows bail payments, particularly for larger amounts, to accumulate gradually, centrally and safely, to be tracked accurately, and to reflect any adjustments by the court process, such as imposition of additional fees or realization of bail reductions. An illustrated embodiment of the present system and method therefore enables third parties to work collectively towards the posting of bail for an individual in a fully automated process. The system provides automatic alerts and executes a payment when a pre-defined balance is achieved. As a corollary, due to its automated nature, this element of the system and method introduces a “transparency” feature not presently a part of the pretrial release system that will allow public administrators, friends, family, associates, the inmates themselves and any other interested parties to monitor progress toward accumulating an amount satisfactory for release.

The system and method of the present disclosure retains all defendant data and contacts in a database. This data facilitates assembling funds and making future payments to inmate trust accounts for recidivists, enabling electronic restitution payments, continuing payments for the benefit of defendants who are convicted and sentenced to confinement, and other law enforcement- and corrections-related payments. The retained data may also be useful for research purposes, provided any confidentiality restrictions are observed, or required legal processes are invoked.

More particularly, in one illustrated embodiment of the present disclosure, a system and method permits incarcerated individuals who have been granted bail but who have not yet paid their bail to access, on a scheduled basis, a trained pretrial release specialist (“Release Expeditor”) by means of an audio or video connection. The Release Expeditor assists the individual in understanding various pretrial release options available in the relevant jurisdiction. The Release Expeditor helps the inmate post his or her own cash bail or bond, assists the inmate in arranging for third parties to pay the inmate's cash bail or bond, and/or enables multiple parties to post the inmate's cash bail or bond to the custodial facility or court through personal credit and debit cards using certain features of the disclosure.

An additional feature of an illustrated embodiment of the present system and method is the electronic acceptance of telephone numbers and Internet and social media feeds, such as blogs, web sites, MYSPACE®, Facebook, LINKEDIN® and Twitter accounts as well as other suitable interpersonal communication pathways obtained from an inmate early in the arrest and incarceration process. The present system uses this information to reach out proactively through automated calls, messaging, emails and various Internet-driven posts to the inmate's personal contacts. This alerts the inmate's personal social network to the inmate's situation and advises these individuals that they may be contacted by the Release Expeditor on the inmate's behalf.

In another illustrated embodiment, an inmate posts his or her own cash bail or bond, or an individual posts cash bail or bond for an inmate by swiping major credit or debit cards through a card reading device connected to a governmental PC, laptop or other computing station. In another illustrated embodiment, an individual accomplishes the same purpose by swiping a major credit card or debit card through a card reading device that is attached to or integrated with a hand-held governmental device capable of wireless communication with a central processing system. Any or all of these embodiments may be used to expedite the payment of other obligations including, but not limited to fines, fees, restitution, or other amounts owed to law enforcement departments. This embodiment may also be used to obtain goods, services, licenses, permits, equipment, supplies and similar considerations from, and satisfy other obligations to governmental or quasi-governmental offices and authorities (each individually, an “Agency” and collectively, “Agencies”).

The GovPayNet system and method described in the present disclosure provides services for individual consumers choosing to use major credit and debit cards or funds sourced from other accounts as a method to pay Agencies. These Agencies have contracted with GovPayNet in advance for its intermediary payment acceptance services on behalf of the Agency and to provide GovPayNet with access to various Agency premises, capabilities systems and accounts in order to facilitate consumer payments to the Agency through the GovPayNet system. The GovPayNet system and method includes a process by which GovPayNet is approved to fulfill the role of a “merchant” directly, or, indirectly as an authorized service provider under various card company/association rules.

Agencies rarely, if ever, accept credit and debit cards directly. Instead, the Agencies contract with various intermediary payment processing companies and service providers to facilitate this payment method. These arrangements, however, may require Agencies to accept “merchant” status, as those card association rules define it, further requiring these Agencies to comply with card association rules that govern all aspects of merchant card acceptance, from proper signage to resolving consumer disputes, to accepting liability for “chargebacks” in situations where the validity of a card transaction is challenged by the cardholder. If the validity of a transaction cannot be established, the charge or debit is reversed. The intermediary companies provide card accepting functionality, but generally do not accept the merchant role.

Using the present system and method allows the Agency to avoid assuming merchant status yet accept credit card and debit card payments. The Agency generally facilitates consumers' contact with GovPayNet, while consumers already familiar with GovPayNet may contact the company directly, by phone or over the Internet, for repeat payments. Generally all payment interaction occurs between GovPayNet and the consumers. Also, as GovPayNet charges a service fee to the consumer, this typically allows GovPayNet to provide Agencies with its basic services at no charge to the Agency. If transaction volumes are high enough and as permitted by local law, GovPayNet may even provide a revenue-sharing option through which the Agency can participate in a share of GovPayNet's fees. The scope of payment methods that are made available through GovPayNet to consumers handling business with an Agency can be more extensive than the service options often provided by other intermediaries.

Finally, as the GovPayNet system and method are provided at no charge (and, potentially, as a revenue source) to an Agency, with no transaction-related liability to the Agency, and only upon the minor conditions of the Agency providing GovPayNet with access to certain accounts and data, an Agency may be able to avoid cumbersome procurement processes involved in retaining a traditional card acceptance intermediary service and contract with GovPayNet directly.

The system and method enables GovPayNet to accept from consumers credit and debit cards for purposes of obtaining transaction authorizations from the card issuers, receiving, managing, and dispersing funds to Agencies, handling customer service to consumers, accepting liability for chargebacks from fraudulent card use or erroneous transactions, and paying any fees charged by the card company or association for card acceptance. GovPayNet processes credit account charges and account debits with full knowledge and authorization from consumers of the costs involved, remits the requested payment to an account that the Agency has selected, and provides Management Information System (“MIS”) reporting to Agencies about the payments. This approach supports and enables the specialized pretrial and other payment services described herein.

The GovPayNet service is nonexclusive to the Agency or the consumers. Agencies typically may discontinue their GovPayNet contract, as they may discontinue contracts with other payment processors, “for convenience” providing Agencies with an easy exit. An Agency that contracts with GovPayNet typically also offers multiple options to post bail and pay fines, fees or other charges. These other options may include, but are not limited to, checks, cash, money orders and electronic checks, or using multiple methods and multiple companies simultaneously for processing various forms of credit card, debit card and electronic funds transfer (“EFT”). These options differ from the consolidation approach taken by the present system which enables multiple parties to easily use multiple funding sources in order to accumulate sufficient funds to satisfy an obligation, with GovPayNet making a single payment to the Agency. For consumers, utilizing the GovPayNet system is another option, with specific features that may make it more attractive to the consumer, depending on individual circumstances.

An illustrated embodiment of the present disclosure provides an automated system to assist with the pre-trial phase of the criminal justice system. Depending on an Agency's specific procedures, the GovPayNet system and method enhances a jurisdiction's inmate processing by acting as a “gateway” to the jurisdiction's pretrial release services. Inmates under pretrial incarceration are awaiting trial. They have not yet been convicted of the crime for which they were arrested. Many have been granted bail, either by a court at a hearing or automatically under a bail schedule set by law. GovPayNet's investigation and research have shown that a large number of bail-eligible inmates at custodial facilities are detained for misdemeanor offenses and granted bail because they do not pose a risk of flight or a danger to the community. The system and method of the present disclosure facilitates servicing those inmates who are bail-eligible and whose bail payment is facilitated by enabling their automated or assisted access to various financial and communications services.

Every day an inmate spends in jail increases costs for security, housing and housekeeping, maintenance, food, and clothing. These costs and other costs can be avoided by assisting defendants who have been granted bail to obtain their legal release. Costs can also increase significantly if a jail stay is long enough to merit a medical history and evaluation. If the evaluation indicates treatment is necessary, or if the inmate becomes seriously ill, costs to the taxpayer can skyrocket, even for an individual inmate. In some Agencies, these evaluations occur even before the offender is incarcerated. Continued incarceration of inmates granted bail simply because they lack the means to effectuate a bail payment or to contact others who may do so quickly and easily imposes both a monetary and social cost. Taxpayers are effectively charged for denying an inmate his or her legally granted freedom.

The present system and method helps control the costs of incarceration, particularly if it is combined with changes in Agency processes to encourage early use of the system to pre-empt as many intake tasks as possible. These changes may be as simple as an inmate being asked to provide various telephone, email and social network contact information at the time of booking, or allowing the inmate temporary access to his or her credit or debit card information. It is intended to be a highly pro-active pretrial release process to replace passive systems in which it is largely the responsibility of the inmate to assemble funds for cash bail or a surety bond. It will also assist defendants who have been granted bail in obtaining their freedom in advance of trial and preparing for or assisting with their defense, which is the essential purpose of bail as a constitutional right.

Multiple methods typically exist for the posting of bail, including the deposit of cash, checks or money orders by the defendant or a friend or family member, the pledging of certain securities or real estate, or the posting of a surety bond purchased from a licensed bail bondsman for a fee that is a percentage of the bond's face amount. As the use of credit cards and debit cards has become more common, jurisdictions have been empowered to accept debit cards and credit cards for the posting of cash bail. Many arrested individuals who have been granted bail and who are in pretrial detention are able to effectuate their release through their own means. Where an Agency has made contractual arrangements to accept cards, through a company like GovPayNet, release may be a simple matter.

When an inmate does not have the wherewithal to post bail in this manner, the inmate must either reach out to friends and family or attempt to use the services of a bail bondsman. In some states, the bail bond business is not legally allowed and cash or credit is the most easily accessible consumer alternatives. Some Agencies contract with a service provider to place a secure kiosk on premises that can accept credit cards, debit cards, or even cash from an inmate or someone acting on the inmate's behalf to post bail, but this requires a physical appearance at the facility. The use of bail-accepting kiosks also results in requirements imposed upon the Agency relating to kiosk space, installation and maintenance. Some Agencies' procedures add the complication of restricting Agency acceptance of bail in any form to specified Agency hours.

These limitations make it difficult for inmates, and for family or friends who are not local or have mobility issues to assist in posting bail. An inmate who does not have sufficient personal assets to post bail faces an additional obstacle: the inability to freely make telephone calls to arrange for bail and the necessity of placing collect calls from the Agency facility to friends and family. Some local telephone service providers and some cell phone service providers actively block calls from jails. Even for calls that the inmate can place, many are refused or, if the inmate reaches an answering machine, cannot be accepted.

The GovPayNet system and method of the present disclosure is available 24/7/365 without geographic limitations. It is suitable to quickly service inmates who have credit or debit cards and replaces the current procedures that disadvantage pretrial inmates who have been granted bail but do not have direct access to enough funds for posting bail. The system and method of the present disclosure makes it easier for the inmates to connect with others who may be able to assist them by moving the key point of interaction with the inmate as far “upstream” as possible in the pretrial incarceration process. It provides the technology to bring to the inmate the real-time services of the Release Expeditor, a human resource trained to bridge the gaps among the inmate, those who can help the inmate post bail if help is necessary, financial service providers, and the Agency.

The system and method of an illustrated embodiment of the present disclosure also brings to the pretrial release process the revolution in social media that continues to impact and enhance how people communicate and connect with each other, and increasingly conduct their business and personal affairs. In one illustrated embodiment, the pretrial release process begins with automated calls, messages, or postings to any phone number or personal electronic media destination the inmate provides at the time of arrest. The Release Expeditor initiates automated telephone calls to individuals who may be able to assist with the posting of bail and who were preferably already alerted by the system's automated messaging feature that such a contact was imminent. Alternatively, the Release Expeditor can assist the inmate by reaching out, in addition to calls, through emails, web postings to social and networking sites, Twitter messages, and/or faxes, as the inmate directs. In another mode, the system automatically initiates follow-up electronic messaging through any or all of these outlets, providing instructions to the recipients on how they may be helpful in effectuating the inmate's release if incarceration is ongoing.

The system and method of the present disclosure also includes a settlement process in which all chargeback risks associated with a credit or debit card transaction are absorbed by GovPayNet. Thus, the Agency may completely rely on the GovPayNet contractual promise to pay the value of all authorized transactions to the Agency's designated bank account electronically and may choose to release the inmate on GovPayNet's transaction confirmation in anticipation of financial settlement in no more than 48 hours. When the released individual appears in court as scheduled, the Agency refunds the cash value of the bail to the individual on whose behalf the bail was posted, as consistent with applicable bail law.

Due to the present system's extensive use of automation and maintenance of a central database for the tracking of funds, the system can serve as a “surrogate” database for Agencies that have minimal to no internal automation or for Agencies that simply want the ability to track bail payment activity through a central, electronic source. As the present system's administration features are accessible via the Internet or other suitable communication network, any individual with an interest in the inmate's bail status is able to track that status via a dedicated web site by inputting the appropriate Agency and inmate identifying data to access publicly available information, kept on the system, regarding the inmate's bail status. This is particularly applicable to situations in which the system is used as an “electronic repository” for funds to accumulate safely and securely towards a larger amount.

The system and method also incorporates video conferencing equipment, which is being used with greater frequency in the judicial and law enforcement systems to economize and streamline Agency operations. This video equipment is used for a variety of purposes, which include conferences between arrestees or inmates and their attorneys, physicians, social workers, parole officers and other system participants, as well as video visitation. Video technology expedites many of the interactions necessary to meet the administrative needs of the Agency while conserving scarce financial resources and maximizing administrative efficiency without inflating the burden on taxpayers or compromising the rights of inmates. And, while some Agencies may be using video conferencing to counsel inmates on different ways to “make bail”, the present system and method extends these capabilities significantly, by linking them to interactions with other services, funding sources, and automated financial processing.

The system and method, however, does not require system-dedicated telecommunications equipment in order to be used by an Agency. Instead, the present system leverages video conferencing equipment already installed for other purposes, expanding the utility of this equipment while introducing new capabilities to assist in managing, and safely reducing, incarcerated populations. An Agency that regularly schedules interviews between a Release Expeditor and inmates can increase the rate at which defendants obtain their release on bail. The anticipated savings to an Agency due to using the system and method of the present disclosure enables an Agency not already equipped for video conferencing to invest in video equipment on this basis alone, leveraging the equipment for many other purposes, such as attorney consultation. Law enforcement Agencies may select hardened video kiosks to guard against wear, tear and vandalism. Such equipment is generally enclosed in stainless steel housings with easy to understand buttons to start and stop a video meeting. The Agency equipment typically includes a durable keyboard to allow the inmate to enter email addresses, URLs, Twitter accounts, Facebook pages, etc. for messaging purposes, if such information is not captured at intake.

Several features distinguish the present system and method from other uses of video conferencing by law enforcement Agencies. In the present system and method, Agencies use the video conferencing equipment to provide consultation on bail and other pretrial release services with the assistance of the Release Expeditor. The Release Expeditor preferably has a background in psychology, sociology, social work, criminal justice or related fields, as well as knowledge of credit and debit card procedures and other financial processing methods. The Release Expeditor is preferably bi-lingual (English and Spanish) and has access to a commercially provided “language line” with translators in nearly 40 other languages.

The system and method of one embodiment of the present disclosure uses video conferencing equipment as a primary intake method because of the personal impact of video conferencing, the connectivity it promotes between inmate and Release Expeditor, and the ability it provides to the Release Expeditor to “read” the inmate's body language and evaluate visual and verbal cues in combination. All of these factors make the video conferencing option superior to audio-only conferencing in effectuating a higher rate of release. By placing a trained Release Expeditor in a new, technologically enabled process flow, aspects of the pretrial release process that have long been the exclusive domain of government programs and not-for-profit organizations may be offered on a for-profit basis.

The Release Expeditor does not provide legal services or legal advice and should clearly disclaim any attorney-client relationship. As described below, the Release Expeditor leverages the payment processing capabilities inherent in the system and method to develop and execute a payment strategy specific to the inmate's circumstances. The strategy often involves using more than one form of payment, including credit and debit cards, EFT, cash, checks, money orders, and electronically funded loans, among other possibilities.

The present system and method enables a new kind and quality of connectivity between inmates and individuals outside of the law enforcement system and a new way of funding payments through multiple payment channels. While some Agencies are proactively reaching out, on an inmate's behalf, by phone to friends or family to encourage these individuals to post bail, the present system and method secures and confirms that an actual electronic bail payment by credit or debit card has been made from a consumer to the Agency during the conversation, accumulates and tracks multiple payment amounts, then alerts the system to execute actual funding or payment when a defined sum is reached. As described throughout, one embodiment of the present method also multiplies this outreach through messaging via social media, as directed by the inmate.

As the use of videoconferencing equipment for judicial and other governmental purposes spreads, expanded use of split-screen conferences is possible, as well as video “hand-offs” to suitably equipped third parties. These include release programs, to continue the visual conversation with the inmate with the assistance of the Release Expeditor or, if appropriate, after the Release Expeditor has exited. Indeed, the Release Expeditor acts as a facilitator of multiple audio and video conferences so that the inmate, pretrial release officials, and other parties, such as probation officers, “halfway houses,” or charitable or religious institutions can participate in structuring a release strategy to present to Agency officials for approval. The visual nature of the system and method facilitates the use of interpreters for hearing-impaired inmates in the pretrial release discussion, as well.

The system and method of one embodiment of the present disclosure also includes a scheduling function to permit automated scheduling of inmate conferences with the Release Expeditor. This scheduling function is used for scheduling other events and encounters, such as consultations with attorneys or court personnel including probation officers and social workers, court appearances, temporary work, home, or medical releases, healthcare management, and visitation, among others. The electronic messaging feature is also utilized to communicate the inmate's schedule to a broader audience, allowing better planning for visitation, court appearances and other purposes.

Pretrial release programs are proven methods for preserving defendants' rights, reducing jail populations and conserving facility operating costs. Conventional programs accomplish this through assisting inmates in obtaining supervised release, securing a reduced bail, or connecting the inmate with bail bondsmen. State and local governments and nonprofit agencies are the typical sources for pretrial services programs. These programs assess the risk that inmates would present if released and provide other information and at times recommendations, including supervision, to judicial officers making bail decisions. Pretrial services play an important part in reducing, or preventing, jail overcrowding.

The proactive approach to pretrial release embodied in the system and method of the present disclosure increases the rate at which defendants who have been granted bail are able to post bail and be released. This enhances the defendants' ability to prepare for their defenses, and also results in considerable savings in Agency operations. If posting cash bail through any of the financial means that the system and method of the present disclosure provides prove not to be the best option or is not feasible, the Release Expeditor is in a position to describe other available pretrial release avenues, recommend, refer, or connect inmates with a recognized pretrial release program or, as another, and possibly last alternative, refer inmates, their families, friends or associates to an approved bail bondsman. Some preliminary information on various alternatives is conducive to an on-screen presentation, much like a cable or satellite television programming guide.

In an illustrated embodiment of the present disclosure, GovPayNet enables the Agency's data processing system to connect with the GovPayNet system via a dedicated, encrypted Internet connection using an integrated interface between the Agency and GovPayNet. The process begins with a daily upload from the Agency of inmates' files to the GovPayNet system. The more information that an Agency provides through its file upload, the more effective the Release Expeditor is in exploring options to enable the inmate's legal release. For example, the uploaded information for each inmate may include, in addition to the bail amount, any outstanding fines, fees, tickets, delinquencies or other monetary obligations and penalties that must be satisfied in addition to the posting of bail necessary for legal release (“Target Balance”).

In illustrated embodiments, the upload of data from the Agency computer includes names, telephone numbers, email addresses and social media locations (if applicable) for individuals the inmate believes could help amass the Target Balance, though some Agency procedural changes may be necessary to facilitate capture of this information. Additional data feeds from the Agency computer update the Target Balance on the GovPayNet system. For example, Agency checks after arrest, incarceration and the setting of bail or imposition of a bail amount from a predetermined schedule may reveal additional warrants, unpaid tickets, delinquent child support, or other amounts owed to public authorities that must be paid in addition to the original bail. The Agency computer provides routine updates by additional uploads or through an online, real time administrative adjustment. Therefore, an updated Target Balance may be calculated by the GovPayNet system. The present system and method collects the financial and social information necessary to assist an inmate granted bail in posting it at any point in the incarceration process in a central, electronic site.

Less sophisticated, smaller Agencies may use alternative procedures to establish inmate data relevant to release on the system, though these will likely involve some degree of manual labor as well as a time lag not present in the fully automated application of the system. These Agencies may also find advantages in using the system and method as a surrogate central database for their own administrative purposes, allowing them to track the bail status of various inmates. This is accomplished by an Agency official accessing the GovPayNet web site over the Internet and using a GovPayNet administrative portal to obtain or update information on the inmate and bail status.

In one embodiment, the financial aspect of the process includes a parameter-driven threshold (i.e., $10,000) for the Target Balance to limit the conferences to inmates who most realistically are able to post bail and pay fees, fines and costs themselves or secure this amount in full with the assistance of others. In another embodiment, the system triggers automatic referrals to licensed and approved bail agents for larger amounts more likely to be the subject of a bail bond. In yet another embodiment, the system operates with no upper limit at all, depending on configuration preferences. The system and method provides Agencies with a number of fields to accommodate other, non-financial data relating to each inmate's case, to the extent an Agency is able to provide input. These fields illustratively include language preference (i.e., English or Spanish), whether the inmate is hearing-impaired, and whether the inmate is the subject of any protective orders or other process that would limit contact with any particular individuals, such as witnesses.

In yet another embodiment, the system is modified for use in juvenile justice systems, or other special circumstances. To the extent relevant inmate information is included as file parameters, the system is programmed to automatically direct files to specific Release Expeditors having the required expertise. The Release Expeditor is familiar with the pretrial procedures and options for pretrial release applicable to each local law enforcement Agency in the jurisdiction with which the system is integrated. The Release Expeditor uses this information in working with the inmate and others on a release plan.

Illustratively, the system receives inmate files from the Agency's case management system by 6:00 AM, Agency local time over a dedicated user interface with the Agency's inmate data processing system. Interfaces are inmate-oriented, to include data fields such as the inmate's name, date of birth, facility identification number, and a unique file identifier for each inmate, among others. The data fields are searchable by all system users, including non-official users. A successful search produces an inmate summary screen displaying the inmate's personal data and system ID, the facility name and ID, and any other information that is pulled from the Agency system, including primary language, photograph, the types of charges and amounts owed, and so forth. Data fields also anticipate the information needed to enable advance automated calls, emails, or messages via social media to the extent the inmate can provide such information.

In addition to accessing demographic data to prepare for the initial conference with the inmate, the system's scheduling feature permits the Release Expeditor to schedule as many conferences as possible by a specified cut-off time, such as before Noon daily. The system automatically communicates a video conference schedule to the Agency, and Agency personnel arranges for inmates to arrive at the appointed time to hold their pretrial release video conference with the Release Expeditor. Agency personnel illustratively provide the inmate with the minimal instruction necessary to utilize the video equipment and initiate the conference.

Once an inmate is in video conference with a Release Expeditor, the Release Expeditor explains the various options available to inmates in that jurisdiction and how the system and method can facilitate them. The Release Expeditor then establishes an audio conference call with a third party, while the inmate and the Release Expeditor each remain in video contact. In one embodiment, this initial call is with an official of a locally recognized governmental or not-for-profit pretrial release program to introduce the inmate to the program and its services. If the inmate is suited for and amenable to the program, the Release Expeditor allows the call to continue between the inmate and the pretrial release program official in audio mode, or a follow-up may take place per any standard program procedures. If the Agency pretrial release program is video-equipped, the Release Expeditor initiates a split-screen conference and ultimately transfers the video conference to the program and exits the discussion, if appropriate. The anticipated savings from fewer and shorter-term incarcerations may allow Agency pretrial release programs to become video-equipped as well.

Agency pretrial release programs are generally focused on the defendant's intake, after which, those who become inmates are “in the system” with reduced prospects of release. The GovPayNet system and method of the present disclosure, however, retains data and keeps files open, which simplifies repeated contact with inmates should their circumstances change in a way that enhances their prospects for release.

Inmates who have credit cards or debit cards in their name may not be interested in the pretrial release program option or have no need for the system's messaging functions, and will instead be prepared to pay the Target Balance immediately. Agencies may choose to revise their inmate intake and processing procedures for purposes of enabling inmates in this category to remain in possession of their own debit or credit cards or, at least, card numbers and necessary card verification data, for purposes of the video interview. The Release Expeditor establishes contact through GovPayNet's web application with the issuer of the card that the inmate makes available while the inmate and the Release Expeditor remain in video contact.

This process is not limited to a single card, however, as the system and method allows the inmate and the Release Expeditor to contact multiple card issuers in a single conference and accumulate multiple payment authorizations. The system also works with “gift cards” sold by many retailers if the cards carry a major card brand and the cardholder has taken the steps required to register the card for use on the Internet. In this way, the Release Expeditor facilitates obtaining the Target Balance, assembled potentially from multiple sources, and executed in a single payment through GovPayNet to the Agency' s designated bank account.

The financial processing capabilities of the system and method of the present disclosure also links inmates to sources of funding other than those accessed by cards. In one embodiment of the present disclosure, payday and other licensed short-term lenders contract with GovPayNet to participate as funding options, particularly those lenders that provide their services online. If a short-term loan is authorized and a funding date established, this information is communicated to the Agency, and the lender deposits loan proceeds with GovPayNet electronically. GovPayNet then transfers the loan proceeds to the Agency using a settlement process similar to that used for card transactions.

The role of the Release Expeditor is particularly important when the inmate is not able to post bail in a sufficient amount using the inmate's own resources. By placing the call for the inmate or sending electronic messages to family, friends or associates, the Release Expeditor enables the inmate to bypass the process of making a collect call, or a call that will show a law enforcement Agency on the caller ID, which may be refused or unanswered. The Release Expeditor checks directory assistance or online telephone directories if the inmate does not know the person's correct phone number.

The Release Expeditor illustratively makes multiple calls and leaves messages on answering machines, avenues that may not be available to the inmate. Again, simple Agency procedural changes can greatly improve system efficacy. These include allowing the offender to temporarily retain his or her cell phone, smart phone, Blackberry or similar personal communication device so that the inmate can provide phone numbers and email addresses of friends and family who may be able to assist in achieving the Target Balance. In a preferred embodiment of the present system and method, this data becomes part of the inmate's file to be uploaded to the system. The present system then automatically initiates a preliminary, automated telephonic or electronic contact to advise potential payors of the inmate's situation in advance of the Release Expeditor's outreach.

When the Release Expeditor initiates a call to a potential payor, the inmate is placed “on hold” (no sound and no live picture) until the Release Expeditor explains to the party called that the call is being placed by GovPayNet on behalf of the inmate on the possibility that the person called may be able to assist the inmate in posting bail and/or paying fines. If the person called agrees to proceed, the Release Expeditor either speaks to the individual as a “go-between” for the inmate or enables audio so the inmate and the individual called may interact directly. The Release Expeditor facilitates a discussion about what is financially necessary for the inmate's release and how the contacted individual may assist through the use of credit or debit cards. In another embodiment, the system and method is configured to allow EFT deposits from an individual's bank account to GovPayNet and, ultimately, to the Agency.

If the Release Expeditor is able to structure a payment with an individual, the inmate will again be placed on hold while the Release Expeditor obtains the necessary account information from the individual called. The Release Expeditor then contacts the bank(s) that issued the credit or debit cards through GovPayNet's automated credit and debit authorization request process, and obtains payment authorization; a process that may be repeated with other individuals until the Target Balance is achieved. By “toggling” between and among participants, the Release Expeditor can manage conversations and contacts with the inmate, the individual called, and the card-issuing banks or other sources of funding, joining multiple parties into, or excluding parties from the audio portion of any call, as appropriate. The present system retains phone numbers, email addresses and other electronic contact information for the inmate in a database for possible future use.

Each Release Expeditor preferably has a working relationship with Agency administrative personnel and pretrial release program personnel. Coordinating the efforts of the Release Expeditor with Agency pretrial release program personnel may result in a lower bail or a bail reduction early in the custodial process. If so, the Release Expeditor may be able to more easily assist the inmate in posting bail through his or her own resources or the resources of a friend or family member. The Release Expeditor is capable of recommending various payment methods, such as cash, check, EFT or money order, in addition to the use of credit or debit cards. Once a file is established for an inmate that includes a payment strategy and Target Balance, if funding is not immediately available, the Release Expeditor may delegate certain functions to GovPayNet customer service representative (“CSR”) staff who can assist the inmate and those interested in the inmate's welfare, without need of the Release Expeditor's expertise and so at a lower hourly labor cost. Simple cases may also be handled by IVR.

In one embodiment, the system and method of the present disclosure is responsible for executing electronic payments. Payments made using cash or negotiable instruments are the responsibility of the inmate or those assisting the inmate. In another embodiment, the system and method is configured to work with an installed kiosk system, even if it is owned and operated by an entity other than GovPayNet, to help coordinate the acceptance of cash and the processing of card-based or other electronic payments on-site. As the system is hardware-neutral, it can accept electronic input from machines designed to accept checks and count coins. Various pricing structures are applied to the users of the payment methodologies. Though the Agency may be charged for enhanced services or peripheral equipment that can augment the system and method, the Release Expeditor and associated services are typically profitably supported on user fees alone.

When the Release Expeditor has arranged and confirmed authorizations for payment of the Target Balance, the system sends an automated notice to the Agency by an agreed-upon method, such as email, fax, system, or text message. Under its contract with GovPayNet, the Agency is assured of the system obtaining funds through the credit card network (or other financial networks) and electronically depositing them to bank accounts as the Agency has directed in advance. At Agencies for which GovPayNet is provided electronic access to deposits to inmate accounts, these funds may be added to the Target Balance. The various funding sources, approved credit and debit card transactions, inmate balances, and cash commitments, are monitored manually or automatically by a system sweep of the various accounts in order to trigger a funding confirmation to the Agency when the Target Balance is reached.

As GovPayNet is the “merchant” for all bail transactions, the major credit card networks guarantee payment to GovPayNet for all transactions that issuers have authorized. GovPayNet then has a contractual obligation to pay the required amounts to the Agency through an electronic settlement process (described below). Agencies take on no risk of chargebacks for denied transactions, for fraudulent use of cards, or claims investigation or the need to handle transaction disputes with consumers, as these all reside with GovPayNet as the merchant. This insulation from liability combined with the certainty of payment the system and method provides allows Agencies to choose to release inmates on receipt of GovPayNet's confirmation of funding. Although the transaction approvals are obtained by the Release Expeditor in real time, GovPayNet settles all payments to the Agency on a (not greater than) 48-hour cycle, obtaining funds from the card networks, lenders, and bank accounts electronically, and then depositing the funds electronically according to instructions obtained from the Agency at the time it contracts with GovPayNet. In some applications of the present system and method, wire transfers are used to deposit funds with Agencies in a more frequent settlement cycle.

If it is not possible for the Release Expeditor to arrange funds through debit cards, credit cards or other automated means sufficient to satisfy the Target Balance, a partial payment may be made through the system pending further funding. Or, the system can keep files open in the event an inmate's circumstances, or the circumstances of the inmate's contacts, change in a way that enables full payment. The duration for keeping a file open is illustratively parameter-driven (i.e., five days, ten days, etc.) and set by GovPayNet and the Agency.

Another embodiment of the present system provides a “self-service” option for accumulating funds over time without the Release Expeditor's involvement. This feature allows the Release Expeditor to establish a temporary web site for the inmate to which individuals may make financial contributions to the Target Balance electronically. The web site is communicated or “advertised” through various methods, such as emails, text messages, or using social media contacts gathered at intake or by the Release Expeditor. Payors are sent e-mail notifications confirming their payments. This feature also includes a system alert when the Target Balance has been obtained, notifying payors and the Agency, executing settlement and updating Agency and GovPayNet files automatically.

Any of these methods may be combined with a “cash commitment” feature, in which individuals (including the inmate) can pledge cash toward the Target Balance. Each pledge is recorded, conditionally, on the system. In one embodiment, a process is used to set a maximum, such as 50% of the Target Balance, above which commitments for cash are not considered. The system tracks cash commitments as transaction data, not as payments, while the Agency is responsible for collecting the cash portion in any number of methods, such as by mail, Over-the-Counter (“OTC”), kiosks, etc. In one embodiment, the computerized interface with the Agency is configured to transmit the Agency's records of cash received on an inmate's behalf to the GovPayNet system as contributions toward the Target Balance. A combination of cash deposits to the Agency and electronic deposits via the system reaching the Target Balance results in an authorization for release.

Having exhausted all means available for obtaining the Target Balance, the Release Expeditor may refer the inmate to any one of Agency-approved bail bondsmen (for larger bail amounts, this may be the first option). An ancillary feature is the use of the present system and method to effectuate a deposit to commissary, telephone or other trust account for the inmate's benefit while he or she remains in custody, especially if there are funds available but they are insufficient to effectuate release, a feature that may also be offered in connection with the temporary web site. As described herein, these amounts on deposit for the inmate's behalf may also be calculated as contributing toward the Target Balance.

If permitted by state or local law, the Agency may earn a rebate or commission on credit and debit card bail payments. The amount of the rebate is set by GovPayNet, as a portion of fees collected from cardholders. Where the business and legal conditions for a rebate are suitable, the present system and method for pretrial release not only reduces cost, but also produces revenue for the Agency.

Several features of the present system and method distinguish it from other systems and methods for accepting debit and credit cards offered to Agencies by traditional credit card and debit card processors that sell to government. Agencies that choose to accept credit and debit cards typically must sign a contract with a processing company that acts as an intermediary providing the Agency with access to the major credit card networks. In many cases, the Agency must agree to act as a “merchant” under card association rules, meaning that the Agency must follow the association rules and various payment card industry standards that apply to the handling consumer card information.

Acting as merchants, Agencies are also responsible to investigate claims by consumers that transactions are incorrect or improper, as well as to accept the liability for chargebacks that result when a consumer successfully challenges the validity of a charge against the consumer's account and the Agency cannot adequately substantiate the transaction. These rules govern all aspects of card acceptance by an authorized merchant, including proper placement of signage and card symbols on web sites, forensic audits, and other requirements, and often represent commitments that many Agencies, especially smaller ones, are reluctant to make. Through the system and method for bail-related payments, GovPayNet is the merchant and accepts all responsibility for investigating and handling consumer claims and disputes and all liability for chargebacks. This way, the Agency gains the convenience of card acceptance for bail-related payments without the administrative burden and financial exposure associated with merchant status under card association rules.

The role of the Release Expeditor is also unique in comparison to the services offered by traditional credit and debit card processors. The Release Expeditor has a specific and recognized area of expertise—understanding and coordinating among pretrial release programs, various related court and law enforcement processes and funding sources—that is not present in banks or third-party processors offering card acceptance processing.

Another embodiment of the present system and method allows Agencies to emulate the OTC convenience a traditional card processor makes available to a consumer who is present in the Agency premises, whether the consumer is the inmate or someone acting on behalf of an inmate. Typically, OTC convenience requires installation of a Point-of-Sale (“POS”) device that is leased by the processing company to the Agency or that the Agency must purchase. A POS-equipped Agency affords consumers the ability to swipe a card to post bail or pay a fine, fee or other obligation.

The POS device has a card swipe aperture, screen, numeric keypad and may be connected to a printer or have its own receipt printing function. The POS also has its own power source, is able to connect to a telephone line, and integrates with the Agency's electronic cash register (“ECR”) system. POS devices communicate the consumer's card information stored on the magnetic stripe to a transaction processing system external to the Agency, so the use by an Agency of a POS device implies additional card security compliance measures and risks.

In this embodiment of the present system and method, GovPayNet provides the Agency with card-swipe convenience without the expense of, or complying with the security requirements associated with full-service POS devices. This is accomplished by equipping an Agency with one or more dual-direction card readers, each with a USB cable and a mounting bracket that allows the Agency to place the devices on an Agency counter. To utilize this embodiment, the Agency is only required to have a computing device, whether a desktop or a laptop, with Internet connectivity and a USB port or other suitable connection. Unlike a POS device, the card reader does not need an independent power source, does not connect to an external processor, and, unless specifically configured to do so, does not print or cause to be printed a receipt (confirmation statements may be printed at any printer attached to the Agency computing station). The function of the card swipe device in the present system and method is to enable a rapid and accurate reading of consumer data from the card's magnetic stripe for transposition to the Agency's computing device. Transaction processing actually occurs over the Internet, where it is encrypted, with security of the consumer's transmitted card information the responsibility of GovPayNet, not the Agency, effectively treating payment of the Target Balance in the same manner as a purchase from an online retailer.

This embodiment is a more effective solution for smaller Agencies than the POS device. The card swipe device relies on telecommunications that support existing Agency computing hardware and is powered through the USB cable or other suitable connection. With no moving parts, screen or keypad, the card swipe devices are highly reliable. If replacement is necessary, a unit can be shipped overnight by any express mail service. Given the low cost and small size of the card swipe device, an Agency may even choose to invest in a supply of back-up devices to minimize downtime. Unlike a POS device, the card reader's purpose is not to transmit consumer information externally, so security needs are less than those associated with the use of POS devices and are more than satisfied by point-to-point encryption between the device and the Agency desktop or laptop computer. Given the reduction of risk and cost, Agencies are also being freed from complex and burdensome procurement processes and can contract directly with GovPayNet or other licensed providers of the system and method.

In this embodiment, GovPayNet enables the Agency's system to connect with the GovPayNet system via the Internet through a link or through an integrated interface between the Agency and GovPayNet. This embodiment of the present system is operating system-neutral, giving it significant flexibility, as it may be used with virtually any major computer operating system that may be in use at an Agency. Whether via link or system integration, however, the system and method opens and activates a file for the transaction and populates data fields on screens developed by GovPayNet, drawing the information directly from the card rather than by Agency personnel keying the information into their computing station. Screens vary to accommodate cards issued by banks outside of the United States.

A series of prompts allows Agency personnel to complete the payment transaction through the GovPayNet web application, which obtains an online, real-time authorization from the card issuer and produces a confirmation which may be printed by the Agency. Using the card reader and an Internet connection to GovPayNet allows GovPayNet, not the Agency, to conduct all interaction with the credit card and debit card issuing company on the consumer's behalf, receive payment electronically from the card system, and, through the GovPayNet settlement process, issue this payment to the Agency. As is the case when in the Release Expeditor mode, the Agency may decide to release the inmate on the basis of the GovPayNet confirmation of transaction authorization back to the Agency, in advance of deposit of actual funds.

Additionally, using the present system to facilitate credit card and debit card payments allows the Agency to offer OTC convenience to consumers to make non-bail related payments, also without accepting the burdens of merchant status. Card association rules allow processors to act as merchants for Agencies up to certain processing thresholds. Beyond those thresholds, the Agency delegates the merchant duties to GovPayNet contractually. Not acting as the merchant helps the non-law enforcement Agency avoid cumbersome processes involved in contracting with a traditional intermediary card acceptance and processing company, the installation of POS devices, and the burden of complying with various security requirements and card association rules as these become the compliance obligation of GovPayNet.

The system is also flexible enough to allow it to be integrated with nearly any existing business or payment accounting system, including but not limited to the Agency's ECR function. The GovPayNet card swipe solution works in tandem with the files established and managed by the Release Expeditor through video conferencing or the “fund raising” web site. An open file may be “closed” simply by the process of swiping a card to process an Internet payment to reach the Target balance, effectuating the release of an inmate.

Like traditional card processors, the GovPayNet system may also be accessed directly by phone or via the web. This access may include “courtesy phones” installed within an Agency's premises, near payment counters. These are toll-free telephones that, when the handset is raised, ring directly into the GovPayNet call center where a bi-lingual CSR (also with access to a language line) will assist consumers in processing bail payments by card.

The system and method of the present disclosure, with its various advantages over traditional card processing and pretrial release services, may also bypass brick-and-mortar premises and computing stations entirely and operate in a wireless mode. In some embodiments, when used with wireless devices (or even satellite phones) that have Internet connectivity and screen and keyboard or keypad capability, the system and method of the present disclosure is used on a remote or mobile basis, such as in patrol cars, patrol boats, or extremely rural Agency locations where other forms of telecommunication are difficult. In this embodiment, a card swipe device may be connected to the wireless device or wireless devices that are already equipped with card swipe apertures may be programmed to be compatible with the GovPayNet system.

Even in areas where telecommunications are not an issue, this wireless embodiment enables Agency officials to bring a payment methodology to cardholders, allowing cardholders to post bail, pay tickets, fines, fees, and satisfy other obligations standing in line as Agency staff no longer “tethered” to their work stations provide a walking payment service. As with the stationary version of the card swipe solution, the wireless version works in coordination with files established by the Release Expeditor.

Whether deployed in its video conference, card swipe, or mobile mode the system and method of the present disclosure provides an improvement over Automated Teller Machines (“ATMs”). An Agency may enable cardholders to obtain cash necessary to post bail and pay other obligations using their credit cards and debit cards by contracting for the installation of ATMs that are convenient to the payment location. Consumers could then use their credit cards for cash advances or debit cards to make withdrawals, then use the cash obtained to post bail or satisfy other obligations to an Agency. ATMs at this time, however, do not accept deposits of checks or cash to accounts other than those controlled by a bank that owns the ATM or which may be affiliated with the ATM provider, so two transactions—accessing cash then taking the cash to an Agency cashier—are required.

Installing ATMs in many law enforcement facilities presents an additional security risk, both to the device itself and to its users. As a “cash dispensing machine” the ATM must be serviced, including replenishing its receipt paper and, most importantly, its supply of cash, creating both costs and an additional security risk. Further, the smallest cash denomination most ATMs distribute is the $20 bill, so users may be required to access cash in excess of the amount required. An ATM also does not provide the extensive MIS available to an Agency through using a dedicated payment system such as the present disclosure. Finally, an ATM requires an installation service, dedicated wall and floor space, a telephone line and a power source in order to operate, far more space and logistical demands than the card swipe device requires. Unlike video conferencing equipment, the ATM cannot be used for other Agency purposes.

A free-standing kiosk may also be used to process payment transactions, from the perspective of an Agency, more effectively than an ATM. Placing a payment kiosk in an Agency facility, however, also necessitates contracting with a vendor, an installation process, wall and floor space, and access to both power and a telecommunication line. A kiosk accepts credit and debit cards and, unlike an ATM, a kiosk will accept cash, but does not dispense it. So, while cash does not need to be replenished, it still needs to be removed and transported creating downtime and security risks. Kiosks also require servicing and present maintenance issues that will either require Agency staff being “talked through” a trouble-shooting process by remote support, or a site visit to repair or possibly even remove and replace the kiosk, which may cause prolonged service interruptions and potentially disrupt Agency operations. Given the expense, risk, requirements and effort associated with a kiosk or an ATM, the number of either device that an Agency may be willing to install is limited.

Unlike ATMs and kiosks, the card swipe embodiment of the present disclosure can be shipped to and installed by Agency personnel with very little instruction. Space needs are minimal as the swipe device can rest or be mounted in various ways on an Agency computing device, desk, counter or other surface. As discussed above, high reliability, limited logistical requirements, simplicity of shipping and installation, the ability to move card readers to other locations and a cost low enough to permit an Agency to maintain an inventory of “spare” card readers makes the card swipe device preferable in many respects to kiosks and ATMs for card-initiated transactions.

In addition to being operating system-neutral, the present system is hardware-neutral. The present system therefore offers a seamless solution that may be implemented with relative ease because it works with current technology and can grow with future technology as it is maintained externally to the Agency. An Agency that contracts with GovPayNet for the present system and method may also maintain a kiosk system if it so chooses, which may be integrated with the GovPayNet system.

Agencies also have the option of making a desktop computer available for public use that would allow consumers to connect to the GovPayNet web site and process a bail transaction directly over the Internet. Thus, any or all of video conferencing, audio conferencing, temporary fund raising web sites, card swipes, wireless access, kiosks, desktop and laptop computers and toll-free courtesy phones may be used in combination with the Release Expeditor service to provide a technologically robust, proactive, and widely accessible bail payment acceptance process.

Whether made available in a video conference, audio-conference, Internet, card-swipe or wireless format, the fee GovPayNet charges to the consumer for use of the service, which is added to the payment amount, offsets the cost of Agency participation in the system. This method of passing costs on to the actual users of the service enables GovPayNet to provide the basic credit and debit card processing service at no cost to an Agency, and allows Agencies to offer consumers a convenient payment method without adding the associated processing fees or costs of chargebacks and claims handling to the public budget. Agencies remain free to purchase enhanced services, including additional card swipe devices or specialized programming, but eventually the present system and method will produce cost savings for the Agency no matter what combination of access modes is implemented while improving the pretrial release process.

The transaction processing component of the present system is authorized by major card associations—American Express, Discover, MasterCard, and Visa—to accept cards from consumers and process payments and transactions for Agencies. This gives consumers the freedom and flexibility to pay when they want, where they want and how they want.

The present system and method offers Agencies total visibility. The system provides access to real-time tracking and reporting so the Agency knows the status of payments and deposits, as well as anticipated rebates (where applicable). The system's MIS includes standardized reports and the ability to create customized reports, making a new cash management tool available for Agency treasurers and comptrollers. The present system also provides new levels of transparency to its non-Agency users, who in some applications are able to track a friend or loved one's progress toward satisfying the Target Balance and obtaining legal release.

In addition to the features described above, the bail payment aspects of the system and method enable law enforcement Agencies to:
Receive bail payments directly and promptly
Collect proper documentation when processing bail payments
Ease overcrowding by processing offenders and defendants faster
Eliminate cash from the Agency's site and the Agency's bail process
Mitigate risk by holding GovPayNet accountable for approved payments
Track payments throughout the process with a real-time reporting feature
Help out-of-state and out-of-town offenders to post bail quickly and easily
Offer inmates and their families a convenient, cost-effective cash bail payment option

The present system and method also retains all defendant data and contacts in a database. Much of the information gathered in the context of posting bail and paying fines and fees is public in nature (other than the specific credit or debit card and account information). If an inmate is eventually convicted of the crime with which he or she is charged, this data can be used to expedite electronic restitution payments, reimbursement of jail processing, court or public defender costs, or continuing payments to the inmate's commissary, telephone, trust or other funded accounts kept by a jail or penitentiary. Data associated with the posting of bail can also be useful for research purposes, provided any confidentiality restrictions are observed, required legal processes are invoked, or specific data elements are masked as may be necessary under applicable rules or laws.

The card swipe feature of the present system and method may be used for many non-bail related payments in the criminal or quasi-criminal justice field, such as impound charges, restitution, court fees, traffic, speeding and parking tickets, among others. In the civil arena, this feature may be used for payment of real estate and property taxes, assessments, state-administered child support payments, utilities, licenses, and other civic obligations. These features enable Agency treasurers to:
Improve the rate and timeliness of collections
Collect proper documentation when processing payments
Eliminate cash from the Agency's site and collections process
Receive payments directly and promptly in the Agency's account
Save time and resources by relying on the accuracy of GovPayNet's systems
Save taxpayer dollars by reducing Agency credit and debit card processing fees
Automate the payment and collections process to reduce administrative burdens
Offer consumers convenient, cost-effective credit and debit card payment options
Mitigate risk by holding GovPayNet accountable for credit and debit card payments
Track payments throughout the process with GovPayNet's real-time reporting feature

Embodiments of the present system and method are configured to read data stored in a driver's license barcode to enhance mobile uses. This feature:
Instantly reads drivers license data from all states into a processing application
Promotes accurate capture of personal information required for the transactions
Speeds time-sensitive transactions and transactions posing some personal risk, such as those performed by police officers on road patrols

In another embodiment, the present system and method uses a desktop computer interface, rather than a web browser, for data entry in environments with restricted Internet access. This feature:
Integrates with card swipe device
Replaces the need for an Internet browser
Offers secure collection and transport of credit and debit card data
Allows the processing of credit and debit card payments in secure environments

The full range of applications of the system and method extend to nearly every area in which a consumer is executing a payment or otherwise delivering funds to an Agency. The present system is suitable for accepting payments to governments including but not limited to:
Bail
Fines
Citations
Court costs
Parole fees
Restitution
Telephone accounts
Commissary accounts
Inmate trust accounts deposits
Child support
Property taxes
Income taxes
Assessments
Filing fees
Permit fees
License fees
Franchise fees
Tuition and books
Transit card accounts
Other public fees (parks, marinas, etc.)

In embodiments of the system and method, Agencies contracting with GovPayNet may earn a commission, where permitted by law and supportable by business conditions, on credit and debit card bail payments.

Although the invention has been described in detail with reference to certain illustrated embodiments, variations and modifications exist within the scope and spirit of the present disclosure as described and defined in the following claims.

1. A method for facilitating release of an offender incarcerated by a governmental agency, the agency having an agency computer, the method comprising:
providing a card swipe device to the agency, the card swipe device being programmed to automatically communicate with the agency computer and automatically obtain information from a card and automatically populate a plurality of data fields in a form on the agency computer supplied by a third-party computing device over a communication network, said card swipe device only being used to obtain information from the card to be displayed on the agency computer to allow a transaction over the Internet, but not to allow a transaction as a point-of-sale device;
Allowing for the manual input of additional information not received from the card to further populate additional data fields in said form on the agency computer;
receiving information over a communication network from an agency computer to the third party computing device, the information including offender and agency identification information, credit/debit card information contained in the data fields of the form populated by swiping a card in the card swipe device, along with said additional information not received from the card to further populate additional data fields, and a proposed payment amount to be applied toward a target balance including at least one of a bail amount, a bond amount, a fine, a fee, a ticket, and a child support obligation owed by the offender;
transmitting the credit, debit, prepaid card or device information and the proposed payment amount from the third party computing device to a payment processing computing device via the communication network in an Internet transaction environment;
receiving an approval for payment of the proposed payment amount from the payment processing computing device with the third party computing device; and
sending confirmation of approval of payment of the proposed payment amount from the third party computing device to the agency computer.

2. The method of claim 1, wherein the card swipe device includes a wireless communication device configured to communicate with the agency computer.

3. The method of claim 1, further comprising receiving an electronic payment of the proposed payment amount from the processing computing device and transmitting an electronic payment of the proposed payment amount to the agency.

4. The method of claim 1, further comprising charging an additional fee with the third party computing device and including the additional fee in the proposed payment amount transmitted from the third party computing device to the payment processing computing device for approval so that the balance is achieved without any charge to the agency for the payment services.

5. The method of claim 4, further comprising receiving an electronic payment of the proposed payment amount and the additional fee from the payment processing computing device and transmitting an electronic payment of the proposed payment amount to the agency.

6. The method of claim 1, further comprising generating a report with the third party computing device, said report comprising information contained in the data fields of the form populated by swiping said card in said card swipe device, and transmitting the report to the agency computer, the report indicating a status of payments received on behalf of the inmate.

7. The method of claim 6, further comprising generating a cashiering report with the third party computing device and transmitting the report to the agency computer, the report indicating daily balances of payments collected by the agency.

8. The method of claim 1, wherein the target balance is calculated by the third party computing device from monetary obligation information received from the agency computer, the monetary obligation information including at least one of a bail amount, a bond amount, a fine, a fee, a ticket, and a child support obligation owed by the offender.

9. The method of claim 1, further comprising transmitting notification from the third party computing device to the agency computer when the target balance to permit release of the inmate from the agency on bail is received.

10. The method of claim 1, wherein the governmental agency avoids assuming merchant status, thereby reducing the governmental agency's risk of chargebacks for denied transactions, fraudulent use of cards, claim investigations, and transaction disputes associated with the payment transaction.

11. A system for facilitating release of an offender incarcerated by a governmental agency, the system comprising:
an agency computer, said agency computer controlled by said governmental agency;
a card swipe device, said card swipe device being coupled to and in communication with said agency computer;
said system being programmed to automatically obtain information from a card when said card is swiped in said card swipe device, and programmed to automatically populate a plurality of data fields in a form on said agency computer, and allowing for the manual input of additional information not received from the card to further populate additional data fields in said form on the agency computer, said form being supplied by a third-party computing device over a communication network, said card swipe device being used only to obtain information from said card to be displayed on said agency computer to allow a transaction over the communication network, and said system does not use said information received from said card for a transaction as a point-of-sale device.

12. The system for facilitating release of an offender incarcerated by a governmental agency of claim 11, wherein said information comprises at least one of offender and agency identification information, credit or debit card information as contained in the data fields of the form populated by swiping said card in said card swipe device, a proposed payment amount to be applied toward a target balance, a bail amount, a bond amount, a fine, a fee, a ticket, and a child support obligation owed by the offender;
wherein said agency computer transmits information over said communication network to said third party computing device, and said third party computing device transmits said credit, debit, prepaid card or device information and said proposed payment amount to a payment processing computing device via the communication network in an Internet transaction environment, and said payment processing computing device provides an approval for payment of the proposed payment amount to said third party computing device, and said third party computing device transmits a confirmation of approval of payment of the proposed payment amount to the agency computer.

13. The system for facilitating release of an offender incarcerated by a governmental agency of claim 11, wherein the card swipe device includes a wireless communication device configured to communicate with said agency computer.

14. The system for facilitating release of an offender incarcerated by a governmental agency of claim 12, further comprising receiving an electronic payment of the proposed payment amount from the processing computing device and transmitting an electronic payment of the proposed payment amount to the agency.

15. The system for facilitating release of an offender incarcerated by a governmental agency of claim 12, further comprising charging an additional fee with the third party computing device and including the additional fee in the proposed payment amount transmitted from the third party computing device to the payment processing computing device for approval so that the balance is achieved without any charge to the agency for the payment services.

16. The system for facilitating release of an offender incarcerated by a governmental agency of claim 15, further comprising receiving an electronic payment of the proposed payment amount and the additional fee from the payment processing computing device and transmitting an electronic payment of the proposed payment amount to the agency.

17. The system for facilitating release of an offender incarcerated by a governmental agency of claim 12, further comprising generating a report with the third party computing device, said report comprising information contained in the data fields of the form populated by swiping said card in said card swipe device, and transmitting the report to the agency computer, the report indicating a status of payments received on behalf of the inmate.

18. The system for facilitating release of an offender incarcerated by a governmental agency of claim 17, further comprising generating a cashiering report with the third party computing device and transmitting the report to the agency computer, the report indicating daily balances of payments collected by the agency.
